(19) United States
(12) Patent Application Publication
(10) Pub. No.: US 2025/0234415 A1
(43) Pub. Date: Jul. 17, 2025

(54) METHODS AND APPARATUSES FOR MANAGEMENT OF A DATA SESSION IN HOME ROUTED SESSION BREAKOUT MODE

(71) Applicant: Nokia Technologies Oy, Espoo (FI)

(72) Inventors: Shubhranshu SINGH, Munich (DE); Laurent THIÉBAUT, Massy (FR); Tezcan COGALAN, Cambridge (GB)

(21) Appl. No.: 19/017,012

(22) Filed: Jan. 10, 2025

(30) Foreign Application Priority Data
Jan. 12, 2024 (GB) 2400434.3

(51) Int. Cl. H04W 76/20; H04W 8/06

(52) U.S. Cl. CPC H04W 76/20; H04W 8/06

(57) ABSTRACT

Techniques for management of a data session in a home routed (HR) session breakout (SBO) mode in a wireless communication system are provided. For example, a method for management of a data session in a HR-SBO mode, comprises: providing, by a home session management function (H-SMF) of a home network to a visited session management function (V-SMF) of a visited network, information on how to influence traffic routing for the data session served by the visited network; and configuring, by the V-SMF, at least a user plane (UP) function based on the information on how to influence traffic routing for the data session.

### TECHNICAL FIELD

The disclosure relates to a wireless communication system. More particularly, the disclosure relates to a method and apparatus for management of a data session in a home routed (HR) session breakout (SBO) mode for a roaming user equipment (UE) and a network in a wireless communication system.

### BACKGROUND

Various embodiments relate to considerations in a (e.g., mobile/wireless) communication system or network, such as a 5G/NR system and a next-generation system beyond 5G. For example, various embodiments are applicable in a 3GPP-standardized mobile/wireless communication system or network of Release 18 onwards.

The wireless communication system such as 5G may support a roaming service for a home routed (HR) user equipment (UE) (referred to as an HR roaming service). In the HR case, data traffic in a visited network (VPLMN) may be routed to a data network through a home network (HPLM). To apply an edge computing service to a roaming UE, an HR session may be broken out to a local data network in which an edge computing server of the visited network is installed. There may be a need for specific procedures related to breaking out the HR session in the visited network.

### List of Acronyms and Abbreviations

The following acronyms and abbreviations are used throughout the present disclosure:
C-DNS Central DNS
C-NEF Central NEF
C-PSA UPF Central PSA UPF
EAS Edge Application Server
EASDF Edge Application Server Discovery Function
ECS Edge Configuration Server
EDC Edge DNS Client
EEC Edge Enabler Client
EES Edge Enabler Server
EHE Edge Hosting Environment
L-DN Local part of DN
L-DNS Local DNS
L-NEF Local NEF
L-PSA UPF Local PSA UPF
HR-SBO Home Routed Session BreakOut

### SUMMARY

It is an object of the present disclosure to provide mechanisms for managing a data session in a home routed (HR) session breakout (SBO) mode in a wireless communication system. There are provided methods and apparatuses for managing a data session in a home routed (HR) session breakout (SBO) mode.

According to some aspects, there is provided the present matter of the independent claims. Some further aspects are defined in the dependent claims.

According to a first aspect of the present disclosure, there is provided a method for management of a data session in home routed (HR) session breakout (SBO) mode. The method may be performed by one or more nodes in a wireless communication system. The method comprises: providing, by a home session management function (H-SMF) of a home network to a visited session management function (V-SMF) of a visited network, information on how to influence traffic routing for the data session served by the visited network; and configuring, by the V-SMF, at least a user plane (UP) function based on the received information on how to influence traffic routing for the data session.

In some examples of the first aspect, the method may further comprise: determining, by the H-SMF, the information on how to influence traffic routing for the data session based on one or more policy and charging control (PCC) rules received from a home policy control function (H-PCF) of the home network.

In some examples of the first aspect, the method may further comprise: receiving, by the H-PCF, a request to influence traffic for the data session provided by an application function (AF); generating, by the H-PCF, the one or more PCC rules based on the request; and providing, by the H-PCF to the H-SMF, the one or more PCC rules.

In some examples of the first aspect, the method may further comprise: receiving, by a home network exposure function (H-NEF) of the home network from the AF, the request to influence traffic for the data session; storing/updating/removing, by the H-NEF, the information on how to influence traffic routing for the data session to a unified data repository (UDR); and sending a notification, by the UDR, the updates on the information on how to influence traffic routing for the data session to the H-PCF of the data session.

In some examples of the first aspect, the method may further comprise: finding, by the H-NEF, the H-PCF of the data session to authorize the request to influence traffic for the data session. In some examples, finding may comprise using a binding support function (BSF) to find the H-PCF.

In some examples of the first aspect, the request to influence traffic may be received by the H-PCF from the AF directly.

In some examples of the first aspect, the information on how to influence traffic routing for the data session may include a request to influence traffic for the data session received from an application function (AF).

In some examples of the first aspect, the information on how to influence traffic routing for the data session includes a subscription request to notifications of any user plane management events received from an application function (AF).

In some examples of the first aspect, the information on how to influence traffic routing for the data session may comprise one or more of: information to identify the traffic, information about one or more data network access identifiers (DNAIs) of the visited network, an indication of traffic correlation, an indication of application relocation possibility, an indication of address preservation for a user equipment, and a request to be notified when a UP path of the data session has changed.

In some examples of the first aspect, the information on how to influence traffic routing for the data session may further comprise, per DNAI, a traffic steering policy identifier and/or traffic routing information related to the interface between a user plane function (UPF) and a data network (DN).

In some examples of the first aspect, providing, by the H-SMF to the V-SMF, the information on how to influence traffic routing for the data session may further comprise using an interface between the H-SMF and the V-SMF to provide the information on how to influence traffic routing for the data session.

In some examples of the first aspect, providing, by the H-SMF to the V-SMF, the information on how to influence traffic routing for the data session may comprise sending, by the H-SMF to the V-SMF, a session management (SM) message or a SM context including an information element or a container to provide the information on how to influence traffic routing for the data session.

In some examples of the first aspect, the method may further comprise providing, by the H-SMF to the V-SMF, offloading rules or information on how the visited network should influence traffic routing for the data session.

In some examples of the first aspect, the method may further comprise: mapping, by the H-SMF, parameters of a request to influence traffic for the data session from one or more PCC rules to parameters to be exchanged between the H-SMF and the V-SMF and providing, by the H-SMF to the V-SMF, the mapped parameters in a session management (SM) message; and expanding the SM message or context with parameters of the request to influence traffic for the data session not mapped to existing parameters.

In some examples of the first aspect, providing, by the H-SMF to the V-SMF, the information on how to influence traffic routing for the data session may comprise providing, by the H-SMF to the V-SMF, a notification endpoint information, the notification endpoint information being used by the V-SMF to send notifications towards an application function (AF) via the home network.

In some examples of the first aspect, the method may further comprise: receiving, by the H-SMF, a request for notification on events on the data session including a notification endpoint information either associated with the AF or associated with a home network exposure function (H-NEF) of the home network via which the request from the AF is received; and providing, by the H-SMF to the V-SMF, an indication that the notification endpoint information provided is the notification endpoint information associated with the AF or the notification endpoint information associated with the H-NEF. In some examples, the indication may be provided when the H-SMF does not provide itself as the notification endpoint information.

In some examples of the first aspect, the method may further comprise: sending, by the V-SMF to the H-SMF, a notification using the notification endpoint information; and forwarding, by the H-SMF to the AF, the notification.

In some examples of the first aspect, the method may further comprise: receiving, by the H-SMF, a request for notification on events on the data session, the request including a notification endpoint information either associated with the AF or associated with a home network exposure function (H-NEF) of the home network; associating, by the H-SMF, a notification endpoint information associated with the H-SMF with the received notification endpoint information; storing, by the H-SMF, the association between the notification endpoint information associated with the H-SMF and the received notification endpoint information; providing, by the H-SMF to the V-SMF, the notification endpoint information associated with the H-SMF as the notification endpoint information to be used by the V-SMF to send notifications on events on the data session towards the AF; receiving, by the H-SMF from the V-SMF, notifications sent using the notification endpoint information associated with the H-SMF; retrieving, by the H-SMF, the notification endpoint information to be used by the H-SMF to forward the notification on events based on the association; and forwarding, by the H-SMF towards the AF, the notifications on events using the retrieved notification endpoint information.

According to a second aspect of the present disclosure, a network node (e.g., a home session management function (H-SMF)) or an apparatus in such a network node is provided. The network node or apparatus may be in a home network of a wireless communication system. The network node or apparatus according to the second aspect comprises at least one processor and at least one memory storing instructions. The instructions cause the network node or apparatus, when executed with the at least one processor, to: provide, to a visited session management function (V-SMF) of a visited network, information on how to influence traffic routing for a data session in a home routed (HR) session breakout (SBO) mode served by the visited network, the information on how to influence traffic routing for the data session used by the V-SMF to configure at least a user plane (UP) function.

In some examples of the second aspect, the instructions may further cause the network node or apparatus, when executed with the at least one processor, to determine the information on how to influence traffic routing for the data session based on one or more policy and charging control (PCC) rules received from a home policy control function (H-PCF) of the home network.

In some examples of the second aspect, the instructions may further cause the network node or apparatus, when executed with the at least one processor, to receive, from the H-PCF, the one or more PCC rules generated based on a request to influence traffic for the data session from an application function (AF).

In some examples of the second aspect, the information on how to influence traffic routing for the data session may include a request to influence traffic for the data session received from an application function (AF).

In some examples of the second aspect, the information on how to influence traffic routing for the data session comprises one or more of: information to identify the traffic, information about one or more data network access identifiers (DNAIs) of the visited network, an indication of traffic correlation, an indication of application relocation possibility, an indication of address preservation for a user equipment, a request to be notified when a UP path of the data session has changed.

In some examples of the second aspect, the information on how to influence traffic routing for the data session further may comprise, per DNAI, a traffic steering policy identifier and/or traffic routing information related to the interface between a user plane function (UPF) and a data network (DN).

In some examples of the second aspect, the instructions may further cause the network node or apparatus, when executed with the at least one processor, to use an interface between the H-SMF and the V-SMF to provide the information on how to influence traffic routing for the data session.

In some examples of the second aspect, the instructions may further cause the network node or apparatus, when executed with the at least one processor, to send, to the V-SMF, a session management (SM) message or a SM context including an information element or a container to provide the information on how to influence traffic routing for the data session.

In some examples of the second aspect, the instructions may further cause the network node or apparatus, when executed with the at least one processor, to provide, to the V-SMF, offloading rules or information on how the visited network should influence traffic routing for the data session.

In some examples of the second aspect, the instructions may further cause the network node or apparatus, when executed with the at least one processor, to map parameters of a request to influence traffic for the data session from one or more PCC rules to parameters to be exchanged between the H-SMF and the V-SMF and provide, to the V-SMF, the mapped parameters in a session management message; and expand the session management message or context with parameters of the request to influence traffic for the data session not mapped to existing parameters.

In some examples of the second aspect, the instructions may further cause the network node or apparatus, when executed with the at least one processor, to provide, to the V-SMF, a notification endpoint information, the notification endpoint information being used by the V-SMF to send notifications towards an application function (AF) via the home network.

In some examples of the second aspect, the instructions may further cause the network node or apparatus, when executed with the at least one processor, to receive a request for notification on events on the data session including a notification endpoint information either associated with the AF or associated with a home network exposure function (H-NEF) of the home network via which the request from the AF is received; and when the H-SMF does not provide itself as the notification endpoint information, provide, to the V-SMF, an indication that the notification endpoint information provided is the notification endpoint information associated with the AF or the notification endpoint information associated with the H-NEF.

In some examples of the second aspect, the instructions may further cause the network node or apparatus, when executed with the at least one processor, to receive, from the V-SMF, a notification using the notification endpoint information; and forward, to the AF, the notification.

In some examples of the second aspect, the instructions may further cause the network node or apparatus, when executed with the at least one processor, to: receive a request for notification on events on the data session, the request including a notification endpoint information either associated with the AF or associated with a home network exposure function (H-NEF) of the home network; associate a notification endpoint information associated with the H-SMF with the received notification endpoint information; store the association between the notification endpoint information associated with the H-SMF and the received notification endpoint information; provide, to the V-SMF, the notification endpoint information associated with the H-SMF as the notification endpoint information to be used by the V-SMF to send notifications on events on the data session towards the AF; receive, from the V-SMF, notifications sent using the notification endpoint information associated with the H-SMF; retrieve the notification endpoint information to be used by the H-SMF to forward the notification on events based on the association; and forward, towards the AF, the notifications on events using the retrieved notification endpoint information.

According to a third aspect of the present disclosure, a home session management function (H-SMF) in a home network is provided. The H-SMF comprises: a communication interface; and at least one processor coupled to the communication interface. The at least one processor is configured to provide, to a visited session management function (V-SMF) of a visited network, information on how to influence traffic routing for a data session in a home routed (HR) session breakout (SBO) mode served by the visited network, the information on how to influence traffic routing for the data session used by the V-SMF to configure at least a user plane (UP) function.

In some examples of the third aspect, the at least one processor of the H-SMF may further be configured to perform one or more of the examples according to the second aspect.

According to a fourth aspect of the present disclosure, a network node (e.g., a home session management function (H-SMF)) or an apparatus in such a network node is provided. The network node or apparatus may be in a home network of a wireless communication system. The network node or apparatus according to the fourth aspect comprises circuitry to provide, to a visited session management function (V-SMF) of a visited network, information on how to influence traffic routing for a data session in a home routed (HR) session breakout (SBO) mode served by the visited network, the information on how to influence traffic routing for the data session used by the V-SMF to configure at least a user plane (UP) function.

In some examples of the fourth aspect, the network node or apparatus may further comprise circuitry to perform one or more of the examples according to the second aspect.

According to a fifth aspect of the present disclosure, a network node (e.g., a home session management function (H-SMF)) or an apparatus in such a network node is provided. The network node or apparatus may be in a home network of a wireless communication system. The network node or apparatus according to the fourth aspect comprises means or modules to provide, to a visited session management function (V-SMF) of a visited network, information on how to influence traffic routing for a data session in a home routed (HR) session breakout (SBO) mode served by the visited network, the information on how to influence traffic routing for the data session used by the V-SMF to configure at least a user plane (UP) function.

In some examples of the fifth aspect, the network node or apparatus may further comprise means or modules to perform one or more of the examples according to the second aspect.

According to a sixth aspect of the present disclosure, there is provided a method performed by a home session management function (H-SMF) in a home network. The method comprises: providing, to a visited session management function (V-SMF) of a visited network, information on how to influence traffic routing for a data session in a home routed (HR) session breakout (SBO) mode served by the visited network, the information on how to influence traffic routing for the data session used by the V-SMF to configure at least a user plane (UP) function.

In some examples of the sixth aspect, the method may further comprise operations of performing one or more of the examples according to the second aspect.

According to a seventh aspect of the present disclosure, a network node (e.g., a visited session management function (V-SMF)) or an apparatus in such a network node is provided. The network node or apparatus may be in a visited network of a wireless communication system. The network node or apparatus according to the seventh aspect comprises at least one processor and at least one memory storing instructions. The instructions cause the network node or apparatus, when executed with the at least one processor, to: receive, from a home session management function (H-SMF) of a home network, information on how to influence traffic routing for a data session in a home routed (HR) session breakout (SBO) mode served by the visited network; and configure at least a user plane (UP) function based on the received information on how to influence traffic routing for the data session.

In some examples of the seventh aspect, the information on how to influence traffic routing for the data session may include a request to influence traffic for the data session received from an application function (AF).

In some examples of the seventh aspect, the information on how to influence traffic routing for the data session may comprise one or more of: information to identify the traffic, information about one or more data network access identifiers (DNAIs) of the visited network, an indication of traffic correlation, an indication of application relocation possibility, an indication of address preservation for a user equipment, and a request to be notified when a UP path of the data session has changed.

In some examples of the seventh aspect, the information on how to influence traffic routing for the data session may further comprise, per DNAI, a traffic steering policy identifier and/or traffic routing information related to the interface between a user plane function (UPF) and a data network (DN).

In some examples of the seventh aspect, the instructions may further cause the network node or apparatus, when executed with the at least one processor, to receive, from the H-SMF, the information on how to influence traffic routing for the data session using an interface between the H-SMF and the V-SMF.

In some examples of the seventh aspect, the instructions may further cause the network node or apparatus, when executed with the at least one processor, to receive, from the H-SMF, a session management (SM) message or a SM context including an information element or a container to provide the information on how to influence traffic routing for the data session.

In some examples of the seventh aspect, the instructions may further cause the network node or apparatus, when executed with the at least one processor, to receive, from the H-SMF, offloading rules or information on how the visited network should influence traffic routing for the data session.

In some examples of the seventh aspect, the instructions may further cause the network node or apparatus, when executed with the at least one processor, to: receive, from the H-SMF, a notification endpoint information; and use the notification endpoint information to send notifications towards an application function (AF) via the home network.

In some examples of the seventh aspect, the instructions may further cause the network node or apparatus, when executed with the at least one processor, to receive, from the H-SMF, an indication that the notification endpoint information is a notification endpoint information associated with the AF or a notification endpoint information associated with a home network exposure function (H-NEF) of the home network.

In some examples of the seventh aspect, the instructions may further cause the network node or apparatus, when executed with the at least one processor, to send, to the H-SMF, notifications using the notification endpoint information.

According to an eighth aspect of the present disclosure, a visited session management function (V-SMF) in a visited network is provided. The V-SMF comprises: a communication interface; and at least one processor coupled to the communication interface. The at least one processor is configured to: receive, from a home session management function (H-SMF) of a home network, information on how to influence traffic routing for a data session in a home routed (HR) session breakout (SBO) mode served by the visited network; and configure at least a user plane (UP) function based on the received information on how to influence traffic routing for the data session.

In some examples of the eighth aspect, the at least one processor of the V-SMF may further be configured to perform one or more of the examples according to the seventh aspect.

According to a ninth aspect of the present disclosure, a network node (e.g., a visited session management function (V-SMF)) or an apparatus in such a network node is provided. The network node or apparatus may be in a visited network of a wireless communication system. The network node or apparatus according to the ninth aspect comprises circuitry to receive, from a home session management function (H-SMF) of a home network, information on how to influence traffic routing for a data session in a home routed (HR) session breakout (SBO) mode served by the visited network; and configure at least a user plane (UP) function based on the received information on how to influence traffic routing for the data session.

In some examples of the ninth aspect, the network node or apparatus may further comprise circuitry to perform one or more of the examples according to the seventh aspect.

According to an eleventh aspect of the present disclosure, a network node (e.g., a visited session management function (V-SMF)) or an apparatus in such a network node is provided. The network node or apparatus may be in a visited network of a wireless communication system. The network node or apparatus according to the eleventh aspect comprises means or modules to receive, from a home session management function (H-SMF) of a home network, information on how to influence traffic routing for a data session in a home routed (HR) session breakout (SBO) mode served by the visited network; and configure at least a user plane (UP) function based on the received information on how to influence traffic routing for the data session.

In some examples of the eleventh aspect, the network node or apparatus may further comprise means or modules to perform one or more of the examples according to the seventh aspect.

According to a twelfth aspect of the present disclosure, there is provided a method performed by a visited session management function (V-SMF) in a visited network. The method comprises: receiving, from a home session management function (H-SMF) of a home network, information on how to influence traffic routing for a data session in a home routed (HR) session breakout (SBO) mode served by the visited network; and configuring at least a user plane (UP) function based on the received information on how to influence traffic routing for the data session.

In some examples of the twelfth aspect, the method may further comprise operations of performing one or more of the examples according to the seventh aspect.

According to a thirteenth aspect of the present disclosure, a computer program product comprises program instructions stored on a computer readable medium to execute steps according to any one of the examples of the methods according to the first, sixth and twelfth aspects as outlined above when said instructions are executed on a computer.

According to a fourteenth aspect of the present disclosure, a non-transitory computer-readable medium containing computer-executable instructions which when run on one or more processors perform the steps according to any one of the examples of the methods according to the first, sixth and twelfth aspects as outline above.

The above-noted aspects and features may be implemented in systems, apparatuses, methods, articles and/or non-transitory computer-readable media depending on the desired configuration. The present disclosure may be implemented in and/or used with a number of different types of devices, including but not limited to cellular phones, tablet computers, wearable computing devices, portable media players, and any of various other computing devices.

This summary is intended to provide a brief overview of some of the aspects and features according to the present disclosure. Accordingly, it will be appreciated that the above-described features are merely examples and should not be construed to narrow the scope of the present disclosure in any way. Other features, aspects, and advantages of the present disclosure will become apparent from the following detailed description, drawings, and claims.

### BRIEF DESCRIPTION OF THE DRAWINGS

A better understanding of the present disclosure can be obtained when the following detailed description of various embodiments is considered in conjunction with the following drawings, in which:

FIG. 1 is a schematic diagram of an example of a (mobile/wireless) communication system or network according to embodiments of the present disclosure;

FIG. 2 is a schematic diagram of an example wireless device or entity according to embodiments of the present disclosure;

FIG. 3 is a schematic diagram of an example network node or entity according to embodiments of the present disclosure;

FIG. 4 is a diagram illustrating a system structure of a 5th generation (5G) system supporting edge computing according to embodiment of the present disclosure.

FIG. 5 is a diagram illustrating a 5G system structure for accessing an edge application server (EAS) of an edge computing service operated in a visited network in an HR roaming scenario according to embodiments of the present disclosure;

FIG. 6 is a flowchart of a method or process for managing of a data session in a HR-SBO mode according to embodiments of the present disclosure;

FIG. 7 is an exemplary message sequence diagram of the methods or processes for managing of a data session in a HR-SBO mode according to embodiments of the present disclosure;

FIG. 8 is another exemplary message sequence diagram of the methods or processes for managing of a data session in a HR-SBO mode according to embodiments of the present disclosure; and

FIG. 9 is yet another exemplary message sequence diagram of the methods or processes for managing of a data session in a HR-SBO mode according to embodiments of the present disclosure.

### DETAILED DESCRIPTION

The examples and embodiments set forth below represent information to enable those skilled in the art to practice the present disclosure. Upon reading the following description in light of the accompanying drawing figures, those skilled in the art will understand the concepts of the description and will recognize applications of these concepts not particularly addressed herein. It should be understood that these concepts and applications fall within the scope of the description.

In the following description, numerous specific details are set forth. However, it is understood that embodiments may be practiced without these specific details. In other instances, well-known circuits, structures, and techniques have not been shown in detail in order not to obscure the understanding of the description. Those of ordinary skill in the art, with the included description, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It is to be noted that the detailed description, at times, refers to one or more specifications being used as non-limiting and illustrative examples for certain architectures, network configurations and system deployments. More specifically, the detailed description refers to 3GPP standards, being used as non-limiting and illustrative examples. As such, the various embodiments provided herein can specifically employ terminology which is directly related thereto. Such terminology is only used in the context of the non-limiting and illustrative examples and is not intended to limit the various embodiments in any way. Rather, any other system configuration or deployment may be utilized while complying with what is described herein and/or various embodiments are applicable to it.

For example, various embodiments are applicable in any (e.g., mobile/wireless) communication system, such as a 5G/NR system and a next-generation system beyond 5G. For example, various embodiments are applicable in a 3GPP-standardized mobile/wireless communication system of Release 18 onwards.

Hereinafter, various embodiments are described using several variants and/or alternatives. It is generally to be noted that, according to certain implementations or constraints, all the described variants and/or alternatives may be provided alone or in any conceivable combination (e.g., also including combinations of individual features of these various variants and/or alternatives).

As used herein, the words “comprising” and “including” should be understood as not limiting the embodiments to consist of only those features that have been mentioned, and embodiments may also contain, among other things, e.g., features, structures, units, modules, or the like, that have not been specifically mentioned.

As used herein, “at least one of the following: <a list of two or more elements>” and “at least one of <a list of two or more elements>” and similar wording, like “one or more of”, where the list of two or more elements are joined by “and” or “or”, mean at least any one of the elements, or at least any two or more of the elements, or at least all the elements.

As used herein, according to various embodiments, any operations of sending or receiving may comprise actual transmission or communication operations, i.e., transmitting or communicating associated messages or signals, but may additionally or alternatively comprise related processing operations, i.e., preparing/generating/issuing associated messages or signals before sending and/or obtaining/handling/processing of associated messages or signals after receiving. For example, sending a message at/by an entity may comprise generating/issuing and/or transmitting/communicating thereof or a corresponding signal in/at/by the entity, and receiving a message at/by an entity may comprise obtaining/handling and/or processing thereof or a corresponding signal in/at/by the entity. As used herein, a message may refer to and/or encompass any kind of corresponding information, signal, or the like.

In the drawings, it is to be noted that lines/arrows interconnecting individual blocks or entities are generally meant to illustrate an operational coupling there-between, which may be a physical and/or logical coupling, which on the one hand is implementation-independent (e.g., wired, or wireless) and on the other hand may also comprise an arbitrary number of intermediary functional blocks or entities not shown. In flowcharts or sequence diagrams, the illustrated order of operations or actions is generally non-limiting and illustrative, and any other order of respective operations or actions is conceivable, if feasible.

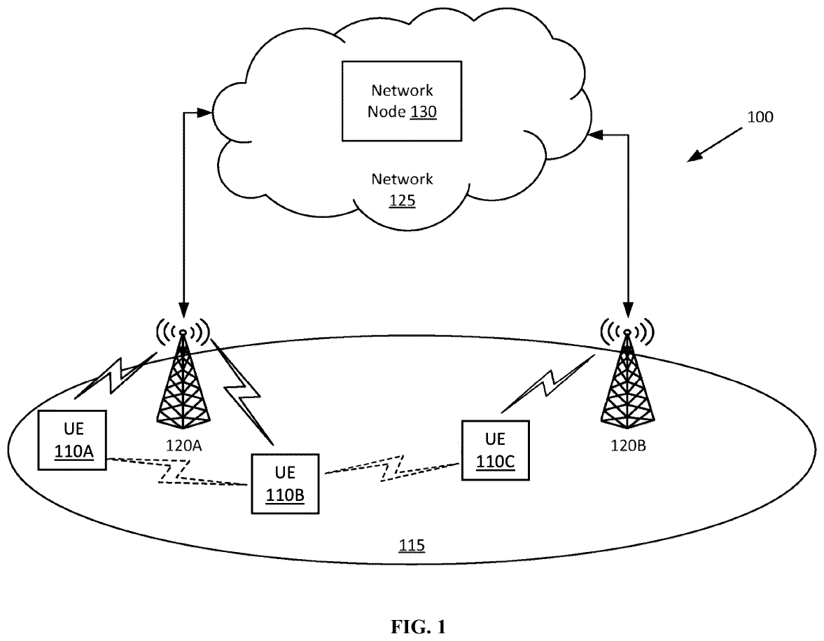

Before explaining various embodiments in detail, certain general principles of a (mobile/wireless) communication system or network are briefly explained with reference to FIGS. 1 to 5 to assist in understanding the technology underlying the described embodiments.

FIG. 1 illustrates an example of a (mobile/wireless) communication system or network 100 according to embodiments of the present disclosure. The embodiment of the communication system or network 100 shown in FIG. 1 is for illustration only. Other embodiments of the communication system or network 100 could be used without departing from the scope of the present disclosure.

As shown in FIG. 1, the communication system or network 100 includes wireless devices or entities, such as UEs 110 (three exemplary UEs 110A-110C are illustrated in FIG. 1), and network nodes or entities, such as radio access nodes 120 (two exemplary radio access nodes 120A-120B are illustrated in FIG. 1) connected to one or more network nodes or entities 130 via an interconnecting network 125, such as the Internet, a proprietary Internet Protocol (IP) network, or other data network. UEs 110 within coverage area 115 may each be capable of communicating directly with radio access nodes 120 over a wireless interface. The radio access nodes 120 may also be referred to as eNBs, gNBs, etc. and communication with each other via the interconnecting network 125.

As an example, UE 110A may communicate with radio access node 120A over a wireless interface. That is, UE 110A may transmit wireless signals to and/or receive wireless signals from the radio access node 120A. The wireless signals may contain voice traffic, data traffic, control signals, and/or any other suitable information.

As used herein, the term “user equipment” (UE) has the full breadth of its ordinary meaning and may refer to any type of wireless device or entity which can communicate with a network node or entity and/or with another UE in a cellular or mobile or wireless/mobile communication system. Depending on the network type, examples of UE are target device, D2D UE, machine type UE or UE capable of machine-to-machine (M2M) communication, personal digital assistant, tablet, mobile terminal, smartphone, laptop embedded equipped (LEE), laptop mounted equipment (LME), USB dongles, ProSe UE, vehicle-to-vehicle (V2V) UE, V2X UE, MTC UE, eMTC UE, FeMTC UE, UE Cat 0, UE Cat M1, narrow band IoT (NB-IoT) UE, UE Cat NB1, etc.

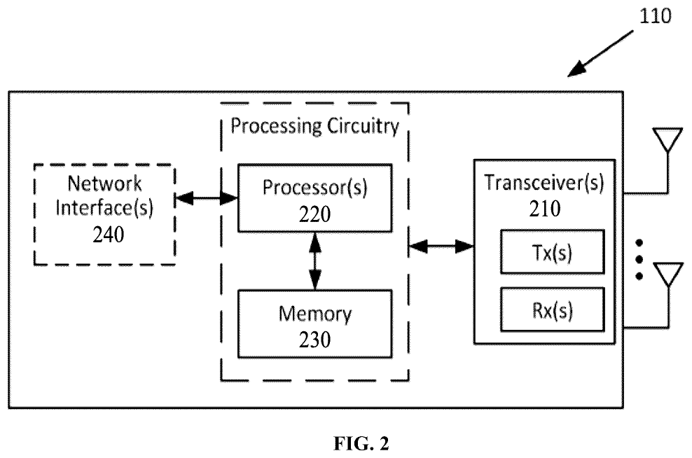

As described in more detail below, one or more of the UEs 110 include circuitry, programing, or a combination thereof, for efficient network management in advanced wireless communication system. Embodiments of a UE are described in more detail below with respect to FIG. 2.

In some embodiments, an area of wireless signal coverage 115 associated with a radio access node 120 may be referred to as a cell. However, particularly with respect to the fifth generation (5G)/New Radio (NR) mobile communication concepts, beams may be used instead of cells and, as such, it is important to note that concepts described herein are equally applicable to both cells and beams.

With respect to a beam-based mobile communication system, the radio access node 120 (base station) may transmit a beamformed signal to the UE 110 in one or more transmit directions (transmission beam, Tx beam). The UE 110 may receive the beamformed signal from the base station 120 in one or more receive directions (reception beam, Rx beam). The UE 110 may also transmit a beamformed signal to the base station 120 in one or more directions and the base station 120 may receive the beamformed signal from the UE 110 in one or more directions. The base station 120 and the UE 110 may determine the best receive and transmit directions, e.g., best in the sense of these directions leading to the highest link quality or fulfilling other quality conditions in the most suitable manner, for each of the base station/UE pairs.

The interconnecting network 125 may refer to any interconnecting system capable of transmitting audio, video, signals, data, messages, etc., or any combination of the preceding. The interconnecting network 125 may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

In some embodiments, the network node 130 may be a core network node, managing the establishment of communication sessions and other various other functionalities for UEs 110. Examples of network node 130 may include mobile switching center (MSC), MME, serving gateway (SGW), packet data network gateway (PGW), operation and maintenance (O&M), operations support system (OSS), SON, positioning node (e.g., Enhanced Serving Mobile Location Center, E-SMLC), location server node, MDT node, etc. UEs 110 may exchange certain signals with the network node 130 using the non-access stratum (NAS) layer. In non-access stratum signaling, signals between UEs 110 and the network node 130 may be transparently passed through the radio access network. In some embodiments, radio access nodes 120 may interface with one or more network nodes 130 over an internode interface.

As used herein, the term “network node or entity” has the full breadth of its ordinary meaning and may correspond to any type of radio access node (or radio network node) or any network node such as a base station (BS), which provide wireless access to a cellular or mobile or wireless communication system and can communicate with a UE and/or with another network node in the cellular or mobile or wireless communication system. Depending on the network type, examples of base stations (BSs) are transmit point (TP), transmit-receive point (TRP), an enhanced base station (eNodeB or eNB), a 5G base station (gNB), a macrocell, a femtocell, a WiFi access point (AP), or other wirelessly enabled devices. Base stations may provide wireless access in accordance with one or more wireless communication protocols, e.g., 5G 3GPP new radio interface/access (NR), long term evolution (LTE), LTE advanced (LTE-A), high speed packet access (HSPA), Wi-Fi 802.11a/b/g/n/ac, etc.

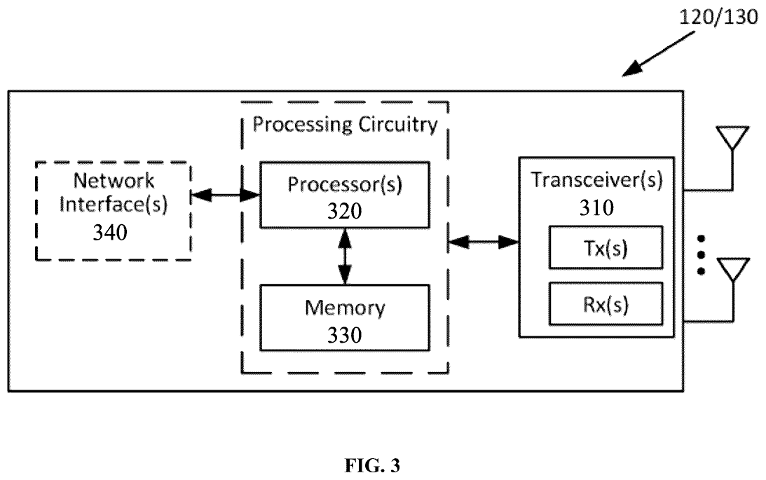

As described in more detail below, one or more of the network nodes such as the radio access nodes 120 includes circuitry, programing, or a combination thereof, for efficient network management in an advanced wireless communication system. Embodiments of a network node are described in more detail below with respect to FIG. 3.

In some embodiments, radio access node 120 may be a distributed radio access node. The components of the radio access node 120, and their associated functions, may be separated into two main units (or sub-radio network nodes) which may be referred to as the central unit (CU) and the distributed unit (DU). Different distributed radio network node architectures are possible. For instance, in some architectures, a DU may be connected to a CU via dedicated wired or wireless link (e.g., an optical fiber cable) while in other architectures, a DU may be connected a CU via a transport network. Also, how the various functions of the radio access node 120 are separated between the CU(s) and DU(s) may vary depending on the chosen architecture.

Exemplary wireless communication systems are architectures standardized by the 3rd Generation Partnership Project (3GPP). A latest 3GPP based development is often referred to as the long-term evolution (LTE) of the Universal Mobile Telecommunications System (UMTS) radio-access technology (RAT). The various development stages of the 3GPP specifications are referred to as releases. More recent developments of the LTE are often referred to as LTE Advanced (LTE-A). The LTE (LTE-A) employs a radio mobile architecture known as the Evolved Universal Terrestrial Radio Access Network (E-UTRAN) and a core network known as the Evolved Packet Core (EPC). Base stations of such systems are known as evolved or enhanced Node Bs (eNBs) and provide E-UTRAN features such as user plane Packet Data Convergence/Radio Link Control/Medium Access Control/Physical layer protocol (PDCP/RLC/MAC/PHY) and control plane Radio Resource Control (RRC) protocol terminations towards the communication devices. Other RAT examples comprise those provided by base stations of systems that are based on technologies such as WLAN and/or Worldwide Interoperability for Microwave Access (WiMax). A base station can provide coverage for an entire cell or similar radio service area. Core network elements include Mobility Management Entity (MME), Serving Gateway (S-GW) and Packet Gateway (P-GW).

An example of a suitable communications system is the 5G or NR concept. Network architecture in NR may be similar to that of LTE-A. Base stations of NR systems may be known as next generation Node Bs (gNBs). Changes to the network architecture may depend on the need to support various radio technologies and finer Quality of Service (QOS) support, and some on-demand requirements for QoS levels to support Quality of Experience (QoE) of user point of view. Also network aware services and applications, and service and application aware networks may bring changes to the architecture. Those are related to Information Centric Network (ICN) and User-Centric Content Delivery Network (UC-CDN) approaches. NR may use multiple input-multiple output (MIMO) antennas, many more base stations or nodes than the LTE (a so-called small cell concept), including macro sites operating in co-operation with smaller stations and perhaps also employing a variety of radio technologies for better coverage and enhanced data rates.

Future networks may utilize network functions virtualization (NFV) which is a network architecture concept that proposes virtualizing network node functions into “building blocks” or entities that may be operationally connected or linked together to provide services. A virtualized network function (VNF) may comprise one or more virtual machines running instructions using standard or general type servers instead of customized hardware. Cloud computing or data storage may also be utilized. In radio communications this may mean node operations to be carried out, at least partly, in a server, host or node operationally coupled to a remote radio head. It is also possible that node operations will be distributed among a plurality of servers, nodes, or hosts. It should also be understood that the distribution of labor between core network operations and base station operations may differ from that of the LTE or even be non-existent.

An example 5G core network (CN) comprises functional entities. The CN is connected to a UE via the radio access network (RAN). An UPF (User Plane Function) whose role is called PSA (PDU Session Anchor) may be responsible for forwarding frames back and forth between the DN (data network) and the tunnels established over the 5G towards the UEs exchanging traffic with the data network (DN). The UPF is controlled by an SMF (Session Management Function) that receives policies from a PCF (Policy Control Function). The CN may also include an AMF (Access & Mobility Function).

Generally, all concepts disclosed herein may be applicable to different communication networks, comprising but not limited to LTE, LTE-A, 5G, 5G advanced, 6G, and other future or already implemented networks.

FIG. 2 is a schematic diagram of an example wireless device (e.g., UE 110 shown in FIG. 1) according to embodiments of the present disclosure.

UE 110 may include one or more of at least one transceiver 210, at least one processor 220, at least one memory 230, and at least one network interface 240. In certain embodiments, the transceiver 210 facilitates transmitting wireless signals to and receiving wireless signals from radio access node 120 (e.g., via transmitter(s) (Tx), receiver(s) (Rx) and antenna(s)). The processor 220 executes instructions to provide some or all of the functionalities described herein as being provided by a wireless device/entity or UE, and the memory 230 stores the instructions executed by the processor 220. In some embodiments, the processor 220 and the memory 230 form processing circuitry.

The processor 220 may include any suitable combination of hardware to execute instructions and manipulate data to perform some or all the described functions of a wireless device or entity, such as the functions of UE 110 described herein. In some embodiments, the processor 220 may include, for example, one or more computers, one or more central processing units (CPUs), one or more microprocessors, one or more application specific integrated circuits (ASICs), one or more field programmable gate arrays (FPGAs) and/or other logic.

The memory 230 is generally operable to store instructions, such as a computer program, software, an application including one or more of logic, rules, algorithms, code, tables, etc. and/or other instructions capable of being executed by a processor 220. Examples of memory 230 include computer memory (for example, Random Access Memory (RAM) or Read Only Memory (ROM)), mass storage media (for example, a hard disk), removable storage media (for example, a Compact Disk (CD) or a Digital Video Disk (DVD)), and/or or any other volatile or non-volatile, non-transitory computer-readable and/or computer-executable memory devices that store information, data, and/or instructions that may be used by the processor 220 of UE 110. For example, the memory 230 includes instructions causing the processor 220 to perform processing according to any corresponding methods described herein.

The network interface 240 is communicatively coupled to the processor 220 and may refer to any suitable device operable to receive input for UE 110, send output from UE 110, perform suitable processing of the input or output or both, communicate to other devices, or any combination thereof. The network interface 240 may include appropriate hardware (e.g., port, modem, network interface card, etc.) and software, including protocol conversion and data processing capabilities, to communicate through a network.

Other embodiments of UE 110 may include additional components beyond those shown in FIG. 2 that may be responsible for providing certain aspects of the wireless device's functionalities, including any of the functionalities described herein and/or any additional functionalities (including any functionality necessary to support the mechanisms according to the present disclosure). As an example, UE 110 may include input devices and circuits, output devices, and one or more synchronization units or circuits, which may be part of the processor 220. Input devices include mechanisms for entry of data into UE 110. For example, input devices may include input mechanisms, such as a microphone, input elements, a display, etc. Output devices may include mechanisms for outputting data in audio, video and/or hard copy format. For example, output devices may include a speaker, a display, etc.

In certain embodiments, the wireless device UE 110 may comprise a series of modules configured to implement the functionalities of the wireless device described herein.

It will be appreciated that the various modules may be implemented as combination of hardware and software, for instance, the processor, memory, and transceiver(s) of UE 110 shown in FIG. 2. Certain embodiments may also include additional modules to support additional and/or optional functionalities.

FIG. 3 is a schematic diagram of an example radio access node 120 or network node or entity 130 according to embodiments of the present disclosure.

Radio access node 120 or network node or entity 130 may include one or more of at least one transceiver 310, at least one processor 320, at least one memory 330, and at least one network interface 340. In certain embodiments, the transceiver 310 facilitates transmitting wireless signals to and receiving wireless signals from wireless devices, such as UE 110 (e.g., via transmitter(s) (Tx), receiver(s) (Rx), and antenna(s)). The processor 320 executes instructions to provide some or all the functionalities described herein as being provided by the radio access node 120 or the network node or entity 130, the memory 330 stores the instructions executed by the processor 320. In some embodiments, the processor 320 and the memory 330 form processing circuitry. The network interface 340 can communicate signals to backend network components, such as a gateway, switch, router, Internet, Public Switched Telephone Network (PSTN), core network nodes or radio network controllers, etc.

The processor 320 can include any suitable combination of hardware to execute instructions and manipulate data to perform some or all the described functions of the radio access node 120 or the network node or entity 130, such as those described herein. In some embodiments, the processor 320 may include, for example, one or more computers, one or more central processing units (CPUs), one or more microprocessors, one or more application specific integrated circuits (ASICs), one or more field programmable gate arrays (FPGAs) and/or other logic.

The memory 330 is generally operable to store instructions, such as a computer program, software, an application including one or more of logic, rules, algorithms, code, tables, etc. and/or other instructions capable of being executed by a processor 320. Examples of memory 330 include computer memory (for example, Random Access Memory (RAM) or Read Only Memory (ROM)), mass storage media (for example, a hard disk), removable storage media (for example, a Compact Disk (CD) or a Digital Video Disk (DVD)), and/or or any other volatile or non-volatile, non-transitory computer-readable and/or computer-executable memory devices that store information. For example, the memory 330 includes instructions causing the processor 320 to perform processing according to any corresponding methods described herein.

In certain embodiments, the network interface 340 is communicatively coupled to the processor 320 and may refer to any suitable device operable to receive input for the radio access node 120 or the network node or entity 130, send output from the radio access node 120 or the network node or entity 130, perform suitable processing of the input or output or both, communicate to other devices, or any combination of the preceding. The network interface 340 may include appropriate hardware (e.g., port, modem, network interface card, etc.) and software, including protocol conversion and data processing capabilities, to communicate through a network.

Other embodiments of the radio access node 120 or the network node or entity 130 can include additional components beyond those shown in FIG. 3 that may be responsible for providing certain aspects of the node's functionalities, including any of the functionalities described herein and/or any additional functionalities (including any functionality necessary to support the solutions described herein). The various different types of radio access nodes or network nodes may include components having the same physical hardware but configured (e.g., via programming) to support different radio access technologies, or may represent partly or entirely different physical components.

Processors, interfaces, and memory similar to those described with respect to FIG. 3 may be included in other nodes or entities (such as UE 110, radio access node 120, etc.). Other nodes or entities may optionally include or not include a wireless interface (such as the transceiver described in FIG. 3).

In certain embodiments, the radio access node 120 or the network node or entity 130 may comprise a series of modules configured to implement the functionalities of the radio access node 120 or the network node or entity 130 described herein.

It will be appreciated that the various modules may be implemented as combination of hardware and software, for instance, the processor, memory, and transceiver(s) of the radio access node 120 or the network node or entity 130 shown in FIG. 3. Certain embodiments may also include additional modules to support additional and/or optional functionalities.

The 3GPP proposed edge computing as a technology to allow services of an operator and/or a third party to be hosted close to an access point, such as a BS, reduce end-to-end latency and load in a network, and thus enable efficient service provision. In the edge computing technology, a data processing time may be shortened by processing data generated at UEs in real time at a short distance from a site where the data is generated without transmitting the data to a central cloud network (hereinafter, referred to as a “central cloud”). For example, the edge computing technology may be applied to a technical field, such as an autonomous vehicle requiring rapid processing in various situations that may occur during driving.

Edge computing is a concept of a network architecture that enables cloud computing functions and service environments, and a network for edge computing may be deployed close to a UE. Edge computing may offer benefits, such as reduced latency, an increased bandwidth, reduced backhaul traffic, and prospects for new services, compared to a cloud environment. A Core Network (CN) beyond 5G or 6th generation (6G) proposed by the 3GPP may expose network information and functions to edge computing applications (hereinafter, referred to as edge applications). In mobile edge computing, a UE may establish a data connection with an edge data network (EDN) close to its location to use a low-latency or broadband service and access an edge application server (EAS) operating in an edge hosing environment or an edge computing platform operated by an Edge Enabler Server (EES) of the EDN, to use a data service.

Enhancements of 5G system to support edge computing are specified by 3GPP, for example, in 3GPP TS 23.548 (e.g., version v18.4.0), which is incorporated herein by reference in its entirety.

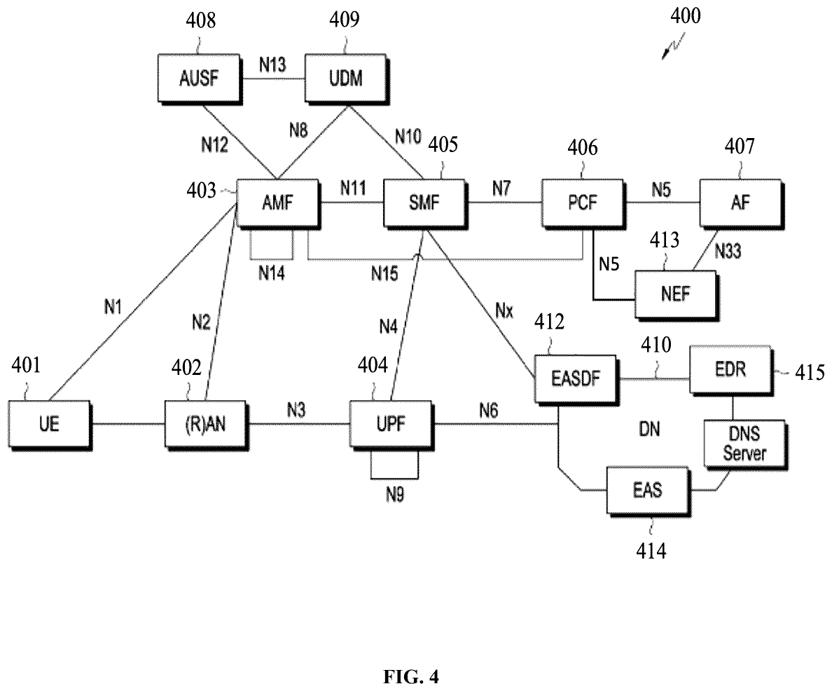

FIG. 4 is a diagram illustrating a system structure of a 5th generation (5G) system supporting edge computing according to embodiment of the present disclosure. The illustrated structure may include various network functions (NFs) depending on system implementation.

Referring to FIG. 4, the network structure of a 5G system 400 may include various network entities. For example, the 5G system 400 may include at least one of an authentication server function (AUSF) 408, a (core) AMF 403, an SMF 405, a PCF 406, an Application Function (AF) 407, a Unified Data Management (UDM) 409, a Data Network (DN) 410, a Network Exposure Function (NEF) 413, an Edge Application Service Domain Repository (EDR) 415, an Edge Application Server (EAS) 414, an EAS Discovery Function (EASDF) 412, a User Plane Function (UPF) 404, a Radio Access Network (RAN) 402, or a UE 401.

In embodiments of the present disclosure, the NFs may support the following functions:

The AUSF 408 may process and store data for authentication of the UE 401.

The AMF 403 may provide functionalities for access and mobility management on a UE basis, and one UE may be basically coupled to one AMF. For example, the AMF 403 may support inter-CN node signaling for mobility between 3GPP access networks, termination of a RAN Control Plane (CP) interface (e.g., N2 interface), termination (N1 interface) of Non-Access Stratum (NAS) signaling, NAS ciphering and integrity protection, Access Stratum (AS) security control, registration management (registration area management), connection management, idle-mode UE reachability (including control and execution of paging retransmission), mobility management control (subscription and policy), support of intra-system mobility and inter-system mobility, support of network slicing, SMF selection, lawful intercept (for AMF events and interfaces to an L1 system), delivery of session management (SM) messages between the UE 401 and the SMF 405, transparent proxy for Session Management (SM) message routing, access authentication, access authorization including roaming authority check, Security Anchor Function (SAF), and/or Security Context Management (SCM). Some or all of the functions of the AMF 403 may be supported in a single instance of an AMF. In a home-routed (HR) scenario (or referred to as a roaming scenario), a visited AMF (V-AMF) may refer to an AMF of a visited network of a subscriber (e.g., the UE 401), and a home AMF (H-AMF) may refer to an AMF of a home network of the subscriber.

The DN 410 may mean, for example, an operator service, Internet access, or a third party service. The DN 410 may transmit a downlink (DL) protocol data unit (PDU) to the UPF 404 or receive a PDU transmitted by the UE 401 from the UPF 404.

The PCF 406 may receive information about a packet flow from an application server (e.g., the AF 407), and provide a functionality of determining a policy, such as mobility management or SM. In embodiments of the present disclosure, the PCF 406 may support functions, such as support of a unified policy framework for controlling a network behavior, provision of policy rules to enable control plane function(s) (e.g., the AMF 403 or the SMF 405) to enforce policy rules, or implementation of a front end for accessing related subscription information for policy making in a User Data Repository (UDR).

The SMF 405 provides a session management function, and when the UE 401 has a plurality of sessions, each session may be managed by a different SMF. In embodiments of the present disclosure, the SMF 405 may support functionalities, such as session management (e.g., session establishment, modification, and release, including maintaining a tunnel between the UPF 404 and the RAN 402), UE Internet protocol (IP) address assignment and management (optionally including authentication), selection and control of user plane (UP) functions, traffic steering configuration for routing traffic to an appropriate destinations at the UPF 404, termination of interfaces toward PCFs, execution of a control part of policy and quality of service (QOS), lawful intercept (for SM events and interfaces to an L1 system), termination of an SM part of NAS messages, DL data notification, AN-specific SM information initiator (transmitted via the SMF 403 over N2 to the RAN 402), determination of SSC mode of a session, or roaming. Some or all of the functionalities of the SMF 405 may be supported in a single instance of an SMF.

The UDM 409 may store subscription data of a user (e.g., the UE 401), and/or policy data. The UDM 409 may include two parts, that is, an application front end (FE) (not shown) and a UDR (not shown).

The FE may include a UDM FE in charge of location management, subscription management, or credentials, and a PCF in charge of policy control. The UDR may store data required for functions provided by the UDM FE, and a policy profile required by the PCF. Data stored in the UDR may include policy data and user subscription data including a subscription identifier (ID), a security credential, access, and mobility-related subscription data, and/or session-related subscription data. The UDM FE may support functionalities, such as accessing subscription information stored in the UDR, authentication credential processing, user identification handling, access authentication, registration/mobility management, subscription management, or session management.

The UPF 404 may forward a DL PDU received from the DN 410 to the UE 401 via the RAN 402 and forward an uplink (UL) PDCU received from the UE 401 to the DN 410 via the RAN 402. In embodiments of the present disclosure, the UPF 404 may support functionalities, such as an anchor point for intra-/inter-radio access technology (RAT) mobility (e.g., a PDU session anchor (PSA)), an external PDU session point of interconnect to a data network, packet routing & forwarding, packet inspection & user-plane part of policy rule enforcement, lawful intercept, traffic usage reporting, a UL classifier for supporting routing of a traffic flow to a data network, a branching point (BP) for supporting a multi-homed PDU session, QoS handling for the user plane (e.g., packet filtering, gating, and UL/DL rate enforcement), UL traffic verification (service data flow (SDF) to QoS flow mapping), transport level packet marking in UL and DL, or DL packet buffering & DL data notification triggering. Some or all of the functionalities of the UPF 404 may be supported in a single instance of a UPF.

The AF 407 may interact with a 3GPP CN in order to provide services (e.g., to support the following: application influence on traffic routing, accessing network capability exposure, and interacting with the policy framework for policy control).

The RAN 402 may generically refer to a radio access network supporting at least one of an evolved version of the 4G RAT, evolved UMTS terrestrial radio access (E-UTRA) or a new RAT (new radio (NR)) (e.g., gNB). The gNB may support functionalities, such as functions for radio resource management (radio bearer control, radio admission control, connection mobility control, dynamic allocation of resources to UEs in both UL and DL (i.e., scheduling)), IP header compression, encryption and integrity protection of a user data stream, selection of an AMF at UE attachment when no routing to an AMF is determined from information provided by the UE, routing of user-plane data towards UPF(s), routing of control-plane information towards an AMF, connection setup and release, scheduling and transmission of paging messages (originated from the AMF), scheduling and transmission of system broadcast information (originated from an operating and maintenance (OAM)), measurement and measurement reporting configuration for mobility and scheduling, transport level packet marking in UL, SM, support of network slicing, QoS flow management and mapping to data radio bearers, support of UEs in inactive mode, distribution function for NAS messages, radio access network sharing, dual connectivity, or tight interworking between NR and E-UTRA. The (R)AN may also correspond to non-3GPP access network corresponding to a N3IWF (for un-trusted non-3GPP access to a 3GPP Core Network), a TNGF (for trusted non-3GPP access to a 3GPP Core Network) or a W-AGF (for Wireline access to a 3GPP Core Network). The 3GPP network being considered may correspond to a PLMN or to an SNPN (Stand-alone Non-Public Network).

The UE 401 may refer to a user device. The UE may be referred to as a terminal, a mobile equipment (ME), a mobile station (MS), and so on. For example, the UE may be a portable device, such as a laptop computer, a mobile phone, a personal digital assistant (PDA), a smartphone, a multimedia device, or the like, or may be a non-portable device, such as a personal computer (PC) or an in-vehicle device.

The NEF 413 may provide means to securely expose services and capabilities provided by 3GPP network functions, for example, including 3rd party, internal exposure/re-exposure, application functions, and/or edge computing. The NEF 413 may receive information from other NF(s) (based on exposed capability(es) of other NF(s)). The NEF 413 may store the received information as structured data using a standardized interface to a UDR. The stored information may be “re-exposed” to other NF(s) and AF(s) by the NEF 413, or used for other purposes, such as analytics.

The EASDF 412 may add the address of a domain name service (DNS) server to which a DNS Query of the UE 401 is to be forwarded, and an extension mechanisms for DNS (EDNS) client subnet (ECS) option which may be expressed as an IP subnet address to be added when the DNS Query of the UE 401 is forwarded, for each fully qualified domain name (FQDN) basis. The EASDF 412 may receive EAS domain configuration information from the EDR 413 and process a DNS Query message received from a UE (e.g., the UE 401) according to the received information. The EASDF 412 may receive a UE IP address, location information about the UE 401 in the 3GPP, DNS message processing rules, and DNS message reporting rules from the SMF 405, process the DNS Query message received from the UE 401 and a DNS Response message received from a DNS server, and transmit information within the DNS messages and statistical information obtained by processing the information to the SMF 405.

While FIG. 4 illustrates a reference model for a case in which the UE 401 accesses one DN 410 by one PDU session, embodiments of the present disclosure are not limited thereto.

The UE 401 may simultaneously access two data networks (e.g., a local DN and a central DN) using multiple PDU sessions. In this case, two SMFs may be selected for the different PDU sessions. In embodiments of the present disclosure, each SMF may have the capability of controlling both a local UPF and a central UPF within a PDU session.

The UE 401 may simultaneously access two data networks (e.g., a local DN and a central DN) provided in a single PDU session.

In the 3GPP system, a conceptual link connecting between NFs is defined as a reference point. For example, reference point(s) included in the 5G system 400 of FIG. 4 are as follows.
N1: reference point between the UE 401 and the AMF 403
N2: reference point between the RAN 402 and the AMF 403
N3: reference point between the RAN 402 and the UPF 404
N4: reference point between the SMF 405 and the UPF 404
N5: reference point between the PCF 406 and the AF 407
N6: reference point between the UPF 404 and the DN 410
N7: reference point between the SMF 405 and the PCF 406
N8: reference point between the UDM 409 and the AMF 403
N9: reference point between two core UPFs 404
N10: reference point between the UDM 409 and the SMF 405
N11: reference point between the AMF 403 and the SMF 405
N12: reference point between the AMF 403 and the AUSF 408
N13: reference point between the UDM 409 and the AUSF 408
N14: reference point between two AMFs 403
N15: reference point between the PCF and the AMF in a non-roaming scenario, and reference point between the PCF and the AMF in a visited network in a roaming scenario
Nx: reference point between the EASDF 412 and another NF (e.g., the SMF 405)

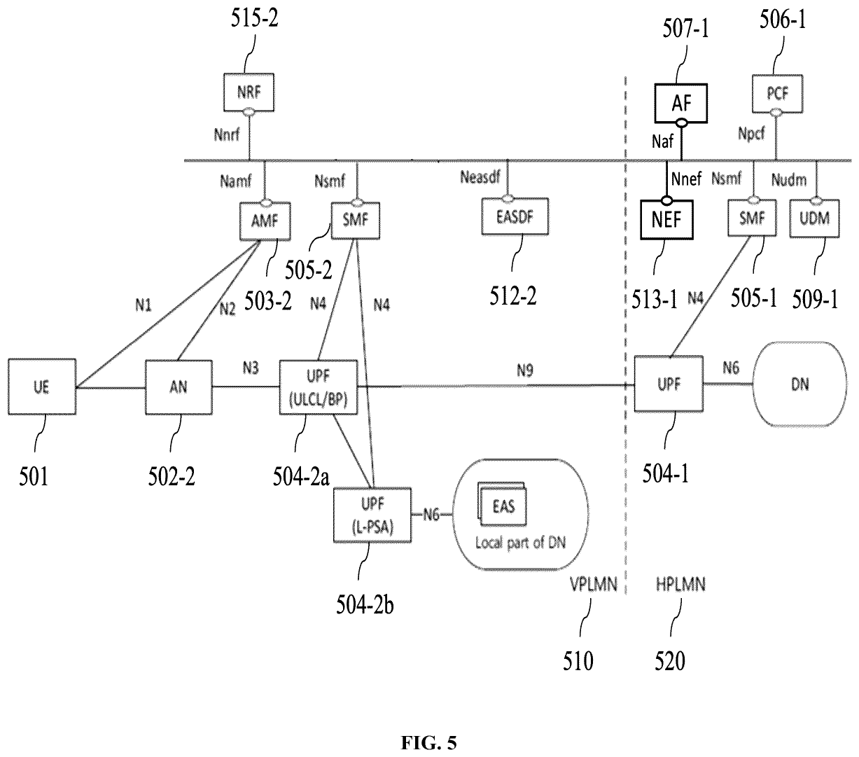

FIG. 5 is a diagram illustrating a 5G system structure for accessing an edge application server (EAS) of an edge computing service operated in a visited network in an HR roaming scenario according to embodiments of the present disclosure.

Referring to FIG. 5, a visited network 510 that may be identified as a visited public land mobile network (VPLMN) may include at least one of an AMF 503-2 (e.g., the AMF 403 shown in FIG. 4), a SMF (also referred to as visited SMF, V-SMF) 505-2 (e.g., the SMF 405 shown in FIG. 4), a UPF (also referred to as visited UPF, V-UPF; not shown) (e.g., the UPF 404 shown in FIG. 4), a EASDF (also referred to as visited EASDF, V-EASDF) 512-2 (e.g., the EASDF 412 shown in FIG. 4), or a DNS server (also referred to as visited DNS server; not shown).

The AMF 503-2 may reside in the visited network 510. In embodiments of the present disclosure, the AMF 503-2 may receive and store a home routed (HR) session breakout (SBO) allowed indication from the UDM 509-1 (e.g., the UDM 409 shown in FIG. 4) in the home network 520 during a registration procedure of the UE 501 (e.g., the UE 401 shown in FIG. 4). The AMF 503-2 may identify a request for data network name/single-network slice selection assistance information (DNN/S-NSSAI) transmitted by the UE 501 in a PDU session creation procedure and transmit the HR-SBO allowed indication to the V-SMF 505-2. In embodiment of the present disclosure, the AMF 503-2 may transmit an address and/or ID of a SMF (also referred to as home SMF, H-SMF) 505-1 (e.g., the SMF 405 shown in FIG. 4) in the home network 520 along with a request for an HR session.

The V-SMF 505-2 may perform tunnel management for a UPF 504-1 (e.g., UPF 404 shown in FIG. 4) in the home network 520 (also referred to as home UPF, H-UPF) through the V-UPF (not shown). The V-SMF 505-2 may determine SBO (a UL classifier (ULCL)/BP) in the visited network 510 and manage a UP session for a local PDU session anchor (L-PSA) UPF 504-2a, a UPF 504-2b, and the V-UPF (not shown) via N4. The V-SMF 505-2 may notify the H-SMF 505-1 that an addition/change/deletion event for a local UPF (e.g., the H-UPF) has been performed by transmitting a HR-SBO indication.

The V-SMF 505-2 may manage a session of the UE 501 in the visited network 510. When the UE 501 requests PDU session creation, the V-SMF 505-2 may receive a PDU session creation request from the AMF 503-2. The V-SMF 505-2 may receive a request including HR-SBO and the ID/address of the H-SMF 505-1 from the AMF 503-2. When the V-SMF 505-2 is capable of receiving a HR-SBO allowed indication from the AMF 503-2, the session is an HR session, and the V-SMF 505-2 has received the ID/IP address of the H-SMF 505-1 from the AMF 503-2, the V-SMF 505-2 may transmit an HR session creation request to the H-SMF 505-1. An indication requesting provisioning of HR-SBO and/or an indication indicating that a HR-SBO function is supported may be transmitted in the HR session creation request to the H-SMF 505-1. The V-SMF 505-2 may transmit the address of the V-EASDF 512-2 (the address of a visited DNS server (V-DNS server)) to the H-SMF 505-1. The V-SMF 505-2 may notify the H-SMF 505-1 of a routing rule for a local data network (LDN).

In embodiments of the present disclosure, the V-SMF 505-2 may determine addition/change/deletion of a ULCL/BP UPF (e.g., the UPF 504-2a) and an L-PSA UPF (e.g., the UPF 504-2a). When the V-SMF 505-2 determines to add the ULCL/BP UPF 504-2a, a network address of the LDN to be forwarded to the L-PSA UPF 504-2b may be reported to the H-SMF 505-1. The H-SMF 505-1 in the home network 520 identified as a home PLMN is responsible for packet forwarding of the HR session.

The V-UPF (not shown) may act as an anchor within the visited network 510 and perform DL data packet buffering for the UE 501 in an idle state and packet forwarding to the H-UPF 504-1 via an N9 tunnel. The V-UPF (not shown) may support the functions of the ULCL/BP UPF 504-2a or the L-PSA UPF 504-2b together. For example, the V-UPF (not shown) may be arranged in the separated form including ULCL/BP UPF 504-2a and L-PSA UPF 504-2b.

The L-PSA UPF 504-2b may function as a local PSA UPF, connect to the LDN via N6, and forward packets transmitted/received to/from an EAS 514-2.

The ULCL/BP UPF 504-2a may perform a PDU branching function. The ULCL/BP UPF 504-2a may receive a packet forwarding rule corresponding to a ULCL from the V-SMF 505-2, and branch and forward a packet received from the UE 501 to the V-UPF (not shown) based on a destination address of the UE 501 and/or an IPV6 prefix of the UE 501.

In embodiments of the present disclosure, the following colocation may be possible according to a specific implementation model:
Colocation of ULCL/BP UPF and V-UPF
Colocation of L-PSA UPF and V-UPF
Colocation of ULCL/BP UPF, L-PSA UPF, and V-UPF

The V-EASDF 512-2 may perform an EAS discovery function in the visited network 510. The V-EASDF 512-2 located in the visited network 510 may be connected to the V-SMF 505-2. The V-EASDF 512-2 may receive DNS message handling rules for a session level and a node level from the V-SMF 505-2. The address of the V-EASDF 512-2 may be used as a DNS address transmitted in a protocol configuration options (PCO) to the UE 501, when a PDU session is created or changed. A home DNS server address may be transmitted to the V-EASDF 512-2 through message handling rules for a DNS Query by the V-SMF 505-2, and used as a DNS server address to which the V-EASDF 512-2 forwards a DNS Query transmitted by the UE 501 which has not registered to a local network, so that the DNS Query is transmitted to a DNS server of the home network 520, for resolution of an IP address for a FQDN included in the DNS Query. Alternatively, the home DNS server address may be used as a default DNS server address. The V-EASDF 512-2 may be located in the LDN. In embodiments of the present disclosure, the V-UPF (not shown) and the V-EASDF 512-2 may be collocated.

The home network 520 may include at least one of a UDM 509-1, a home PCF (H-PCF) 506-1, the H-SMF 505-1, the H-UPF 504-1, or a home DNS server (not shown), a NEF (also referred to as home NEF, H-NEF) 513-1 (e.g., the NEF 413 shown in FIG. 4), and serve an AF (also referred to as home AF, H-AF) 507-1 (e.g., the AF 407 shown in FIG. 4).

The H-PCF 506-1 may be a PCF of the home network 520 and determine policies for an HR session. The H-PCF 506-1 may receive a report of an AF request received from an AF 507-1 through an NEF 513-1 of the home network 520 through a UDR (not shown), receive an AF influence traffic routing policy, and the H-SMF 505-2 may determine an SBO policy based on the AF influence traffic routing policy received from is H-PCF 506-1.

In embodiments of the present disclosure, AF traffic influence from the AF 507-1 of the home network 520 may be delivered to the H-SMF 505-1 in the following path: Home AF (H-AF) 507-1->Home NEF (H-NEF) 513-1->Home UDR (H-UDR) (not shown)->Home PCF (H-PCF) 506-1->Home SMF (H-SMF) 505-1.

The UDM 509-1 may record whether HR-SBO is allowed, for each DNN/S-NSSAI of a UE according to roaming pre-agreement between PLMNs. The UDM 509-1 is an NF that indicates whether HR-SBO is allowed to the AMF 503-2 through the visited network 510 of the UE 501 during registration.

The H-SMF 505-1 may receive an SM-related context from the UDM 509-1 and determine whether to support HR-SBO. When the H-SMF 505-1 allows HR-SBO, the H-SMF 505-1 may transmit a HR-SBO allowed ack indication to the V-SMF 505-2. A DNS server address of a PCO message transmitted to the UE 501 is set to the address of the V-EASDF 512-2 provided by the V-SMF 505-2. The H-SMF 505-1 may transmit a raw data collection request to the V-SMF 505-2 to collect raw data for charging. The V-SMF 505-2 may collect usage data from the V-UPF (not shown) through a usage reporting rule (URR).

The UE 501 exchanges 5G control-plane messages with the AMF 503-2. The UE 501 may access the EAS 514-2 via a PDU session through the UPFs on the user plane. The UE 501 may receive the DNS server address from the V-SMF 505-1. The UE 501 may transmit a DNS Query to the DNS server address.

In embodiments of the present disclosure, an AMF (e.g., the AMF 503-2) may operate as follows: The AMF may obtain HR roaming session policy configuration information (e.g., including an HR roaming session policy indication indicating VPLMN controlled policy decision or HPLMN controlled policy decision) from a UDM (e.g., the UDM 509-1), select an SMF (e.g., the V-SMF 505-2) in consideration of the information, and transmit the HR roaming session policy configuration information to the SMF.

In embodiments of the present disclosure, The H-SMF 505-1 may obtain SM policy information related to the HR roaming SBO from the H-PCF 506-1, determine information on how to influence traffic routing for a data session (e.g., a PDU session) in the HR-SBO mode served by the VPLMN and deliver the information on how to influence traffic routing for the PDU session in the HR-SBO mode to the V-SMF (e.g., the V-SMF 505-2), that can then configure UPF(s) in the VPLMN that serve the PDU session. For example, the V-SMF may configure the UPF(s) with corresponding N4 rules related to a UP path configuration (e.g., including a ULCL and a configuration of a local V-PSA UPF) based on the information obtained from H-SMF 505-1.

Accordingly, as illustrated in FIG. 5, when roaming, the UE 501 establishes a home routed session that is capable of supporting session breakout in the visited network 510 based on the subscription. In this scenario, the home network 520 and the visited network 510 have an agreement on the support of the local traffic routing (i.e., session breakout performed by V-SMF 505-2 also called HR-SBO) in visited network 510 for the home routed session.

After establishing the HR-SBO PDU session, the UE 501 can access EAS deployed in Edge Hosting Environment (EHE) in the visited network 510 while the UE 501 can also access the data network (DN) in the home network 520.

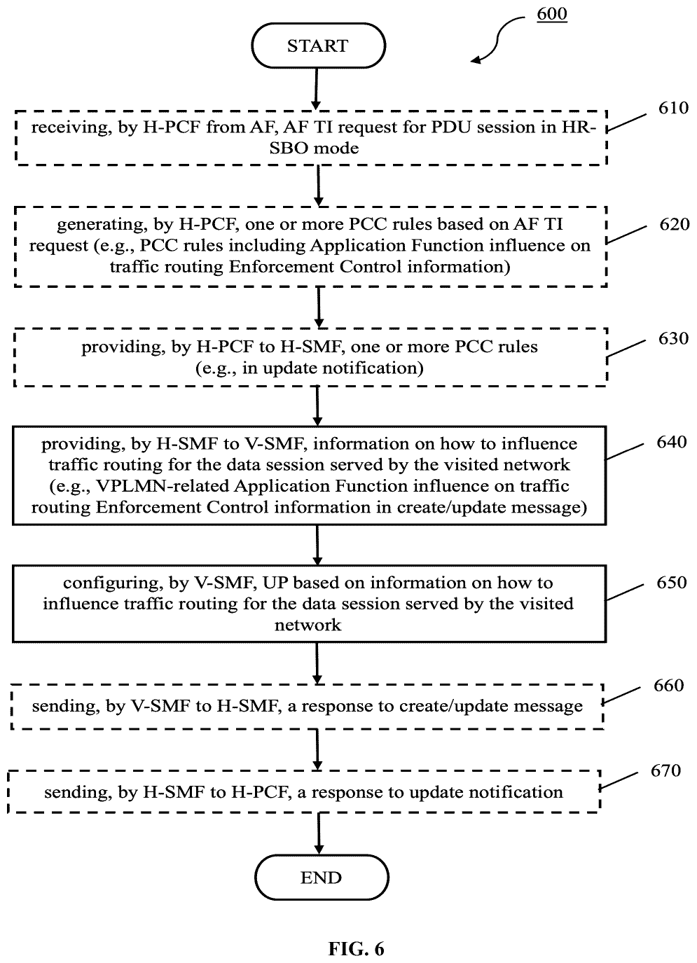

Before referring to FIGS. 6 to 9 and describing the methods for management of a data session in a home routed (HR) session breakout (SBO) mode (i.e., in the HR-SBO scenario) according to embodiments of the present disclosure, some background information and aspects related to the present disclosure will be provided.

In the 5G system as described above, the insertion, change or removal of the V-SMF for an HR-SBO session follows procedures defined as part of Rel-16 study item on Enhancing Topology of SMF and UPF in 5G Networks (ETSUN). Procedures for Intermediate-SMF (I-SMF) insertion, change or removal are specified in clause 4.23 of 3GPP TS 23.502 (e.g., version v18.4.0), which is incorporated herein by reference in its entirety. In clause 6.7.2 of 3GPP TS 23.548, the insertion, change or removal of V-SMF procedures are specified by replacing the I-SMF with V-SMF and SMF with H-SMF along with the differences specific to the HR-SBO scenario. The procedures cover inter V-SMF inter-PLMN N2 handover and mobility registration as well as inter V-SMF intra-PLMN N2 handover and Xn handover or mobility registration update in the HR-SBO scenario. During V-SMF insertion, change or removal, SM context is exchanged between V-SMFs or H-SMF and V-SMF and vice versa.

In the 5G system, the Application Function (AF) may send requests to influence traffic routing decisions for user plane traffic. The AF request may influence the UPF (re) selection and allow routing of user traffic to a local Data Network (DN) or Edge Application Server (EAS). The AF request may target an individual UE or a group of UEs. Procedures related to AF influence on traffic routing are specified in clause 5.6.7 of 3GPP TS 23.501 (e.g., version v18.4.0), which is incorporated herein by reference in its entirety, clause 4.3.6 of 3GPP TS 23.502, and clauses of 3GPP TS 23.548. For example, as part of clause 6.7.3 of 3GPP TS 23.548, EAS rediscovery and edge relocation procedures are defined. Accordingly, EAS rediscovery and edge relocation in VPLMN can be triggered due to UE mobility, AF interacting with HPLMN or AF interacting with VPLMN.

However, support for local traffic offloading in the VPLMN for the Home Routed PDU session in the roaming scenario (i.e., the HR-SBO scenario) requires certain considerations which need to be made and are addressed by embodiments of the present disclosure. For example, the embodiments of the present disclosure enable a trusted or an untrusted 3rd party AF to influence a HR-SBO PDU session, allow the V-SMF to send notifications to the AF that has influenced PDU session via the HPLMN, allow the H-SMF to convey AF traffic influence request to the V-SMF for the HR-SBO session(s) served by the VPLMN, and enable providing EAS IP replacement information during V-SMF insertion or change for both cases when the change happens within the same VPLMN or between VPLMNs.

Now, exemplary methods for managing a data session in a home routed (HR) session breakout (SBO) mode according to embodiments of the present disclosure will be described.

FIG. 6 illustrates a flowchart of a method 600 or process for managing a data session in a home routed (HR) session breakout (SBO) mode according to embodiments of the present disclosure. The method 600 or process may be performed in a wireless communication system. For example, the method 600 or process may be performed in a 5G system supporting access to an edge application server (EAS) of an edge computing service operated in a visited network in an HR roaming scenario as described above with reference to FIG. 5. The wireless communication system may comprise a visited network (VPLMN) and a home network (HPLMN) having the system structure as described above with reference to FIGS. 4 and 5.

The method 600 may be performed by one or more network nodes or network functions of a wireless communication system, including a Base Station (BS). In some examples, the method 600 may be performed by an apparatus in, or for use in, such one or more network nodes or network functions. For example, the one or more network nodes may be represented by any one of the networks nodes, such as gNBs 120A-120B or network node 130 of the wireless network 100 as described above with reference to FIG. 1, the network node 120/130 as described above with reference to FIG. 3, or one or more of the network functions as described above with reference to FIGS. 4 and 5.

According to embodiments of the present disclosure, the method 600 for managing a data session such as a Protocol Data Unit (PDU) session in a HR-SBO mode comprises providing, by a home session management function (H-SMF) of the home network (HPLMN) to a visited session management function (V-SMF) of the visited network (VPLMN), information on how to influence traffic routing for the data session served by the visited network (see operation 640 of FIG. 6) and configuring, by the V-SMF, a user plane (UP) (or at least a UP function) based on the received information on how to influence traffic routing for the data session (see operation 650 of FIG. 6).

In some examples, the method 600 may start at operation 610. At operation 610, an Application Function (AF) of the home network may send the request to influence traffic (also referred to as AF TI request) for the data session in the HR-SBO mode served by the visited network to a Home Policy Control Function (H-PCF) of the home network.

For example, in 5G system, the AF may send the traffic influence request to modify traffic routing decisions based on internal triggers or user-plane related events such as UE mobility. In general, the AF may send the traffic influence request to the serving PLMN directly or indirectly as such:
in case UE is not roaming, the AF may send the request to HPLMN (i.e., H-NEF) directly;
in case UE establishes a Local BreakOut (LBO) session and there is a Service Level Agreement (SLA) between the AF and the VPLMN (serving PLMN), the AF may send the request to the VPLMN (i.e., V-NEF) directly;
in case UE establishes an HR-SBO session and there is an SLA between the AF and the VPLMN (serving PLMN for the HR session), the AF may send the request to the VPLMN (i.e., V-NEF) directly; and
in case UE establishes an HR-SBO session and there is no SLA between the AF and the VPLMN (serving PLMN for the HR session), the AF may interact with the HPLMN (i.e., H-NEF) to send traffic influence request to VPLMN; this is also considered where the AF sends the request to influence traffic for the HR-SBO session to VPLMN (i.e., the serving PLMN) via HPLMN of the UE that has the HR-SBO session.

In some examples, the AF may send the request to influence traffic for the data session in the HR-SBO mode to the H-PCF via a Home Network Exposure Function (H-NEF) of the home network. That is, the AF may send the request to influence traffic to the H-NEF. In response to receiving the request to influence traffic, the H-NEF updates the information into a unified data repository (UDR), which then notifies the same to the H-PCF of the data session in the HR-SBO mode.

In other examples, the AF may send the request to influence traffic for the data session in the HR-SBO mode to the H-PCF directly (i.e., not via the H-NEF).

As part of AF TI request, the AF may also invoke edge application server (EAS) instance change/relocation (as specified e.g., in clause 6.3.3 of 3GPP TS 23.548). To enable the EAS change/relocation without including the UE in the process (in a way that the UE is not aware of EAS change/relocation, e.g., destination IP address change), EAS IP replacement may be used. Using notification procedure, the SMF may notify the AF about a capability of supporting EAS IP replacement. During EAS change/relocation, if the AF received the capability information, the AF may provide EAS IP replacement information including source and target EAS IP address(es) and port number(s).

In operation 620, the H-PCF may generate or update one or more PCC rules based on the request to influence traffic. For example, the one or more PCC rules generated or updated by the H-PCF may include AF influence on traffic routing Enforcement Control information that relates to content of the request to influence traffic (e.g., the traffic influence API). The one or more PCC rules may also include other information such as information for charging and Quality of Service (QOS) control. In some examples, the one or more PCC rules may also include the request to influence traffic.

In some examples, the one or more PCC rules may comprise one or more of: information to identify the traffic to be influenced, information about one or more Data Network Access Identifiers (DNAIs) of the visited network, an indication of traffic correlation, an indication of application relocation possibility, an indication of address preservation for a user equipment (UE), and a request to be notified when a UP path of the data session in the HR-SBO mode has changed. In some examples, the one or more PCC rules may further comprise, per DNAI, a traffic steering policy identifier and/or traffic routing information (e.g., N6 traffic routing information) related to the interface between a User Plane Function (UPF) and a Data Network (DN) such as N6. In some examples, the N6 traffic routing information may be included, if the N6 traffic routing information is explicitly provided in the request to influence traffic.

In operation 630, the H-PCF may provide the one or more generated or updated PCC rules to the H-SMF of the home network. For example, the H-PCF may send an update notification message related to session management policy control (e.g., Npcf_SMPolicyControl_UpdateNotify) including the PCC rules to the H-SMF.

That is, in the HR-SBO scenario, the H-PCF may provide VPLMN specific offloading policy including IP ranges/FQDN(s) allowed to be routed to the local part of the DN in the visited network to the H-SMF.

The H-SMF may determine, or derive, the information on how to influence traffic routing for the data session in the HR-SBO mode based on the one or more PCC rules received from the H-PCF. For example, the H-SMF may determine, or derive the information on how to influence traffic routing for the data session in the HR-SBO mode based on the AF influence on traffic routing Enforcement Control information that relates to content of the request to influence traffic or based on the request to influence traffic, included in the PCC rules. That is, the information on how to influence traffic routing for the data session in the HR-SBO mode (also referred to herein as visited network-related (e.g., VPLMN-related) Application Function influence on traffic routing Enforcement Control information) may represent information corresponding to a part of the PCC rules.

In operation 640, the H-SMF provides the information on how to influence traffic routing for the data session in the HR-SBO mode to the V-SMF of the visited network. For example, the H-SMF may provide the information on how to influence traffic routing for the data session in the HR-SBO mode by sending the same via Session Management (SM) signaling if traffic offloading is allowed for the data session in the HR-SBO mode. For example, the H-SMF may send a create or update message related to a PDU session (e.g., Nsmf_PDUSession_Create/Update) such as the data session in the HR-SBO mode or a Session Management (SM) Context to the V-SMF. The message sent to the V-SMF may include the information on how to influence traffic routing for the data session in the HR-SBO mode in an information element or a container related to AF traffic influence (also referred to as AF TI container). That is, the information element or the container includes, or provides, the information on how to influence traffic routing for the data session.

For example, similar to the PCC rules received by the H-SMF, the information on how to influence traffic routing for the data session in the HR-SBO mode may comprise one or more of: information to identify the traffic, information about one or more data network access identifiers (DNAIs) of the visited network, an indication of traffic correlation, an indication of application relocation possibility, an indication of address preservation for a user equipment, and a request to be notified when a UP path of the data session has changed. In some examples, the information on how to influence traffic routing for the data session in the HR-SBO mode may further comprise, per DNAI, a traffic steering policy identifier and/or traffic routing information (e.g., N6 traffic routing information) related to the interface between a User Plane Function (UPF) and a Data Network (DN).

The H-SMF may provide the information on how to influence traffic routing for the data session in the HR-SBO mode to the V-SMF using the N16 or N16a interface with the information element or the container (transparent or non-transparent) dedicated to AF TI-related PCC rules/rule updates (e.g., as the AF TI container).

In some examples, the H-SMF may provide the information on how to influence traffic routing for the data session in the HR-SBO mode, or the AF TI request, as part of VPLMN Specific offloading rules/information. For example, the VPLMN Specific offloading rules/information may include the AF TI container. The AF TI container may also be used to convey some, or all, of the parameters/information elements defined/used in existing AF requests as specified by 3GPP TS 23.503 (e.g., version v18.4.0), which is incorporated herein by reference in its entirety.

In some other examples, the H-SMF (or the H-PCF) may also map the information elements as part of the AF TI request to already existing parameters exchanged between the H-SMF and the V-SMF such as the SM Context. The information elements not mapped to any other existing parameter may be send as individual parameters in an expanded version of the existing message/context (e.g., the SM Context).

That is, in the HR-SBO scenario, the H-SMF may generate VPLMN specific offloading information and provide this information to SMF at the serving PLMN, that is the V-SMF.

In operation 650, the V-SMF configures, or reconfigures, the UP based on the information on how to influence traffic routing for the data session in the HR-SBO mode. For example, the V-SMF may consider the information on how to influence traffic routing for the data session in the HR-SBO mode and reconfigure the user plane, e.g. N4 rules update, PSA-UPF insertion or relocation, DNAI change, EAS relocation decision, and any required notification if requested.

In response to (re-)configuring the user plane, in operation 660, the V-SMF may send a create or update response message related to the PDU session (e.g., Nsmf_PDUSession_Create/Update Response) to the H-SMF. In addition, in operation 670, the H-SMF may send an update notification message (response) related to session management policy control (e.g., Npcf_SMPolicyControl_UpdateNotify) to the H-PCF.

According to some embodiments of the present disclosure, the exemplary methods for managing a data session in a HR-SBO mode may further include providing a notification endpoint information (e.g., Unified Resource Identifier (URI) information of the H-SMF) from the H-SMF to the V-SMF. The notification endpoint information may be provided in operation 640 shown in FIG. 6 (e.g., as part of the information on how to influence traffic routing for the data session in the HR-SBO mode or the AF TI container). For example, the H-SMF may send the notification endpoint information to the V-SMF as part of the Nsmf_PDUSession_Create/Update. The V-SMF may use the notification endpoint information to send notifications towards the AF via the home network. More specifically, using the notification endpoint information, the V-SMF may send notifications to the H-SMF which may forward at least some of the notifications to the AF (either directly or via H-NEF).

In some examples, the H-SMF may provide the notification endpoint information to the V-SMF in response to receiving a request for notification on events on the data session (e.g., from the AF). The request for notification may include a notification endpoint information associated with the AF, or if the request is received via the H-NEF, a notification endpoint information associated with the H-NEF. The H-SMF may maintain internally an indication of the notification endpoint information to allow notifications from the V-SMF to be forwarded to the AF either directly or via the H-NEF. In other words, the H-SMF may handle notification from the V-SMF and re-map the notification to the AF or the H-NEF.

In some examples, when the H-SMF does not provide its own notification endpoint information, the H-SMF may provide an indication that the notification endpoint information is the notification endpoint information associated with the AF or the notification endpoint information associated with the H-NEF to the V-SMF.

In some examples, the notification endpoint information (e.g., the URI information) may be provided as part of the SM context with an information element as part of AF coordination information. For example, the information element including the notification endpoint information may be included in the SM context as specified in 3GPP TS 23.502.

According to some embodiments of the present disclosure, the exemplary methods for managing a data session in a HR-SBO mode may further include receiving, at the H-SMF, a request for notification on events on the data session. The request may include a notification endpoint information either associated with the AF or associated with a home network exposure function (H-NEF) of the home network. The H-SMF may associate a notification endpoint at the H-SMF (i.e., a notification endpoint information associated with the H-SMF) with the notification endpoint at the AF or the H-NEF (i.e., the notification endpoint information associated with the AF or the H-NEF) and stores the association between the notification endpoint at the H-SMF and the notification endpoint at the AF or the H-NEF (i.e., the association between the notification endpoint information associated with the H-SMF and the notification endpoint information associated with the AF or the H-NEF). The H-SMF may then provide the notification endpoint information associated with the H-SMF as the notification endpoint information to the V-SMF (e.g., as part of the information on how to influence traffic routing for the data session in the HR-SBO mode). The notification endpoint information may be used by the V-SMF to send notifications on events on the data session towards the AF (i.e., to the H-SMF). The H-SMF may retrieve, or determine, the notification endpoint information to be used by the H-SMF to forward the notification on events based on the stored association. That is, the H-SMF uses the notification endpoint information used by the V-SMF to send the notifications on events on the data session to retrieve, or determine, a notification endpoint information associated with the AF or the H-NEF based on the stored association. The H-SMF may then use the retrieved or determined notification endpoint information associated with the AF or the H-NEF to forwarding the notifications on events towards the AF (e.g., via the H-NEF).

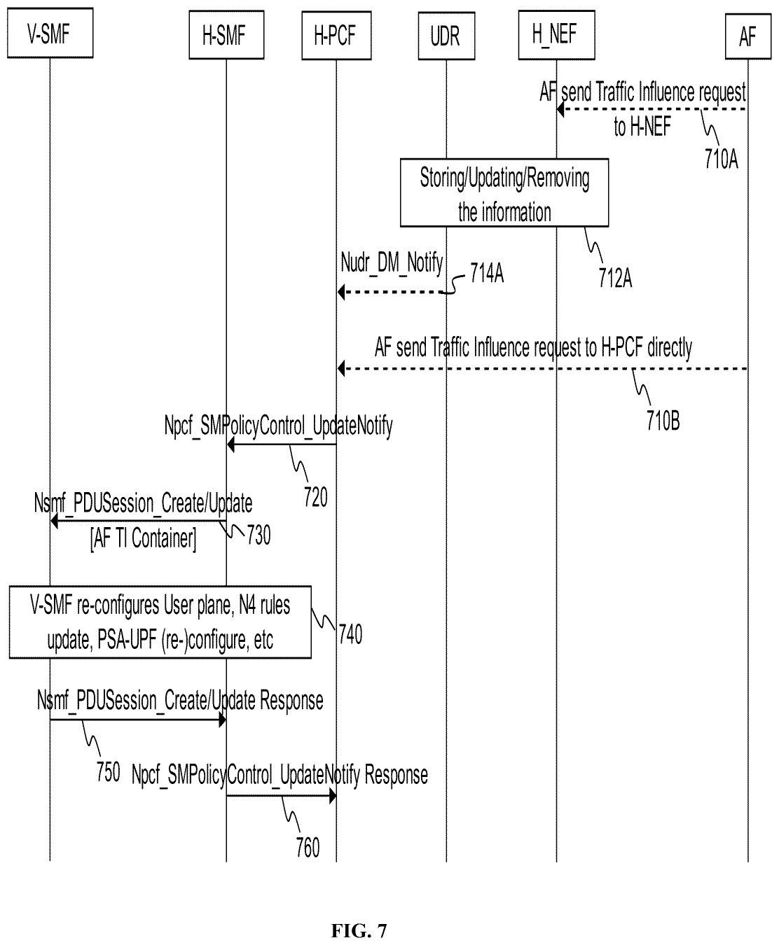

Exemplary message sequence diagram of the methods or processes for managing of a data session in a HR-SBO mode according to embodiments of the present disclosure will now be described with reference to FIGS. 7 to 9. The method or processes for managing of the data session in the HR-SBO mode according to embodiments of the present disclosure are related to the HR-SBO scenario to support local traffic routing in the visited network for home routed PDU session for roaming as described with reference to FIG. 5.

Referring to FIG. 7, an exemplary message sequence diagram of the method or process for managing of a data session (e.g., a PDU session) in a HR-SBO mode according to embodiments of the present disclosure is illustrated. The exemplary message sequence diagram illustrates signaling an AF traffic influence request from a home network (e.g., HPLMN) to a visited network (e.g., VPLMN) in the HR-SBO scenario illustrated in FIG. 5.

The AF (e.g., AF 507-2 shown in FIG. 5) interacts with the home network (e.g., HPLMN) to influence traffic for the PDU session in the HR-SBO mode served by the visited network (e.g., VPLMN). For example, the AF may send a traffic influence request to the home network. The traffic influence request may be sent directly to the Policy Control Function of the home network (e.g., H-PCF 506-1 shown in FIG. 5) in step 710B or via the Network Exposure Function of the home network (i.e., H-NEF) in step 710A. In case, the traffic influence request is sent via the H-NEF (step 710A), the H-NEF may store/update/remove the information to influence traffic for the HR-SBO session (i.e., the PDU session) to Unified Data Repository (UDR) in step 712A. In this case, when there is an update on the information to influence traffic for the HR-SBO session, the UDR sends a notification to H-PCF of the HR-SBO session in step 714A. For example, the UPF may send Nudr_DM_Notify to the H-PCF in step 714A. In some examples, the H-NEF may use a Binding Support Function (BSF) to find the H-PCF for the PDU session.

In response to receiving the traffic influence request, the H-PCF may generate or update one or more policy and charging control (PCC) rules based on the traffic influence request. The PCC rules to be generated or updated may comprise information required to enable user plane detection of the policy control and proper charging for a service data flow. For example, the PCC rules may comprise AF influence on traffic routing Enforcement Control information that relates to content of the request to influence traffic.

For example, the PCC rules may contain information to identify the traffic, information about the VPLMN DNAI(s) towards which the traffic routing should apply and optionally, an indication of traffic correlation and/or an indication of application relocation possibility and/or indication of UE IP address preservation, and a request to be notified when a UP path of the data session has changed. The PCC rules may also contain per DNAI a traffic steering policy ID and/or N6 traffic routing information, if the N6 traffic routing information is provided in the traffic influence request.

In step 720, the H-PCF may provide the one or more generated/updated PCC rules to the Session Management Function of the home network (e.g., H-SMF 505-1 shown in FIG. 5). For example, the H-PCF may send an update notification (e.g., Npcf_SMPolicyControl_UpdateNotify) signaling the one or more generated/updated PCC rules to the H-SMF.

In step 730, the H-SMF may send to the V-SMF the received traffic influence information (e.g., received as PCC rules from the H-PCF). The H-SMF may also determine Application Function influence on traffic routing Enforcement Control information related to the visited network (i.e., VPLMN-related Application Function influence on traffic routing Enforcement Control information) and provides the VPLMN-related Application Function influence on traffic routing Enforcement Control information to the SMF in the visited network (e.g., V-SMF 505-2 shown in FIG. 5). For example, the H-SMF may send the VPLMN-related Application Function influence on traffic routing Enforcement Control information to the V-SMF by invoking a message (e.g., Nsmf_PDUSession_Create/Update) towards the V-SMF.

In some examples, the message may include the VPLMN-related Application Function influence on traffic routing Enforcement Control information (i.e., information on how to influence traffic routing for the PDU session in the HR-SBO mode or traffic influence related information according to the traffic influence request) in an information element or a container (also referred to as AF traffic influence (TI) container). The H-SMF may provide the VPLMN-related Application Function influence on traffic routing Enforcement Control information to the V-SMF using the N16 or N16a interface including the AF TI container. In some examples, the AF TI container may be a transparent or non-transparent container dedicated to AF traffic influence-related PCC rules or rule updates.

In some examples, some or all of the parameters/information elements defined/used in the AF request provided in Table 5.6.7-1 of 3GPP TS 23.501 or Table 6.3.1 of 3GPP TS 23.503 may be conveyed as part of the AF TI container in the N16 or N16a interface from the H-SMF to the V-SMF in step 730.

In step 740, the V-SMF considers the VPLMN-related Application Function influence on traffic routing Enforcement Control information (i.e., the information in the AF TI container) and (re-)configures a user plane (UP) (or at least a UP function) based on the VPLMN-related Application Function influence on traffic routing Enforcement Control information to influence traffic for the PDU session in the HR-SBO mode. Reconfiguring the user plane may include PSA-UPF (e.g., PSA-UPF 504-2b) insertion or relocation, DNAI change, EAS relocation decision, N4 rules update, and any required notification if requested. In some examples, the V-SMF may also generate or update one or more PCC rules based on the VPLMN-related Application Function influence on traffic routing Enforcement Control information and configure the UP based on these one or more PCC rules.

In step 750, the V-SMF may acknowledge the VPLMN-related Application Function influence on traffic routing Enforcement Control information received in step 730. For example, the V-SMF may send a message (e.g., Nsmf_PDUSession_Create/Update Response) to the H-SMF to acknowledge receipt of the message (e.g., Nsmf_PDUSession_Create/Update) received in step 730.

In response to receiving the acknowledgement from the V-SMF, the H-SMF may send a response (e.g., Npcf_SMPolicyControl_UpdateNotify) to the H-PCF in step 760.

In other words, the exemplary message sequence diagram of FIG. 7 is to provide the AF traffic influence request sent to H-NEF/H-PCF to V-SMF via H-SMF. In this example of the method or process for managing of the PDU session in the HR-SBO mode according to embodiments of the present disclosure, the V-SMF inserted into the PDU session (i.e., the PDU session in the HR-SBO mode) may provide the DNAI list the V-SMF supports to the H-SMF. In some examples, this list may remain constant during the N16 or N16a association between the V-SMF and the H-SMF for the PDU session.

Additionally, or alternatively, in the exemplary message sequence diagram of FIG. 7 and the example of the method or process for managing the PDU session in the HR-SBO mode according to embodiments of the present disclosure, the AF traffic influence request (i.e., the traffic influence request received in step 710) or the VPLMN-related Application Function influence on traffic routing Enforcement Control information may be provided as part of specific offloading rules/information related to the visited network (also referred to as VPLMN specific offloading policy) from the H-SMF to the V-SMF.

In such examples, an AF TI container as described above may be used to convey some or all of the parameters/information elements defined/used in the AF request provided in Table 5.6.7-1 of 3GPP TS 23.501 or Table 6.3.1 of 3GPP TS 23.503.

An example for including the AF TI container as part of the VPLMN specific offloading policy is shown in the following table:

TABLE
PDU Session related policy information

| VPLMN Specific | HR-SBO policy for the local |
|---|---|
| Offloading Policy | part of DN in VPLMN. |
| IP range(s) | IP address range(s) allowed to |
| | be routed to the local part of |
| | DN in VPLMN. |
| FQDN(s) | FQDN(s) allowed to be routed |
| | to the local part of DN in |
| | VPLMN. |
| Authorized DL | Defines the DL Aggregate Maximum |
| Session AMBR | Bit Rate for the Non- |
| for Offloading | GBR QoS Flows of the |
| | PDU Session authorized for |
| | offloading to the local part |
| | of DN in VPLMN. |
| AF TI Container | VPLMN-related Application |
| | Function influence on traffic |
| | routing Enforcement Control |
| | information, e.g. information |
| | related with AF traffic influence |
| | derived by H-SMF from |
| | Application Function influence |
| | on traffic routing Enforcement |
| | Control information within |
| | PCC rules received by H-SMF; |
| | Application Function influence |
| | on traffic routing Enforcement |
| | Control information has been |
| | provided to the H-SMF as part |
| | of AF interactions to influence |
| | traffic routing (in the |
| | VPLMN). |

In these examples, the procedure of using Offload Identifier(s) as specified in 3GPP TS 23.548 may be used to send the (updated) traffic influence request from the AF.

Additionally, or alternatively, in the exemplary message sequence diagram of FIG. 7 and the example of the method or process for managing the PDU session in the HR-SBO mode according to embodiments of the present disclosure, the H-SMF may map the information elements as part of the AF traffic influence to existing parameters exchanged between the H-SMF and the V-SMF as part of Session Management (SM) signaling such as Nsmf_PDUSession_Create/Update. In such examples, the information elements that are not mapped to any other existing parameter may be send as individual parameters in an expanded version of the existing message/context.

Additionally, or alternatively, in the exemplary message sequence diagram of FIG. 7 and the example of the method or process for managing the PDU session in the HR-SBO mode according to embodiments of the present disclosure, the H-SMF may send the AF TI container as part of PDU session information the H-SMF sends to V-SMF via SM related signaling (Nsmf_PDUSession_Create/Update).

As will be described in more detail hereinbelow, in an example of the exemplary message sequence diagram of FIG. 7 and the method or process for managing the PDU session in the HR-SBO mode according to embodiments of the present disclosure, the H-PCF may provide in, or together with, the one or more PCC rules notification endpoint information (e.g., information including the H-NEF Notification Endpoint) for the SMF to notify to the H-NEF. For example, 5GC determined information related to the UE members of the set of UEs identified by traffic correlation ID may be notified.

Furthermore, as will also be described in more detail hereinbelow, in another example of the exemplary message sequence diagram of FIG. 7 and the method or process for managing the PDU session in the HR-SBO mode according to embodiments of the present disclosure, the H-PCF may provide in, or together with, the one or more PCC rules information to subscribe the AF (or the H-NEF) to SMF events (e.g., UP path changes) corresponding to the AF traffic influence request. In this example, the information on AF subscription to corresponding SMF events received in the AF traffic influence request are provided, for example, by providing policies at PDU session set-up or by initiating a PDU session modification procedure. More specifically, the H-SMF may initiate the set-up and modification procedures towards the V-SMF.

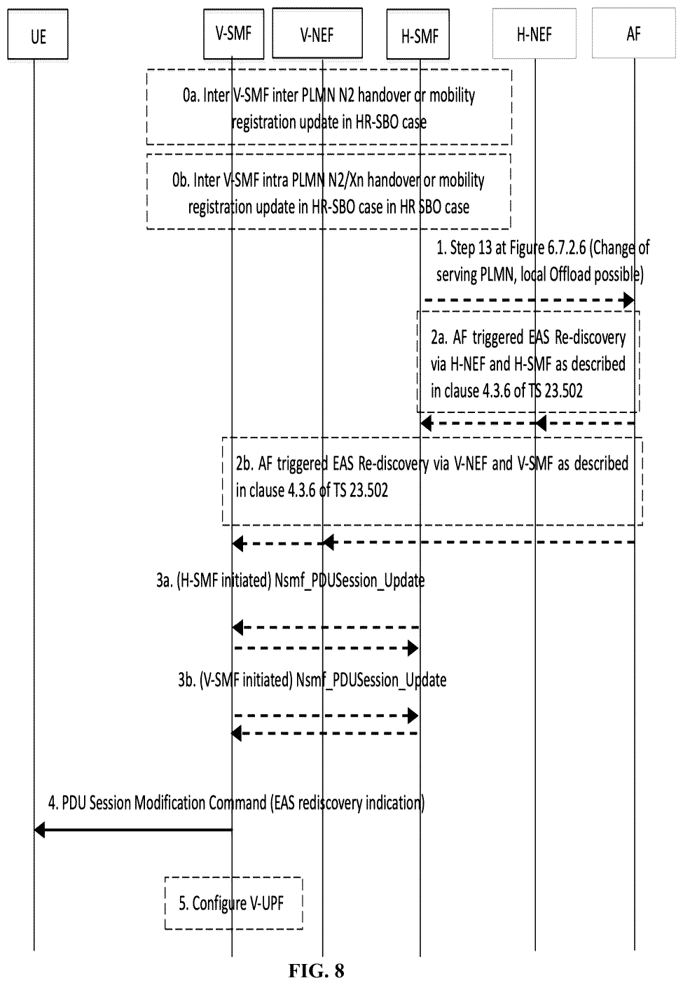

Referring to FIG. 8, an exemplary message sequence diagram of the method or process for managing a data session in a HR-SBO mode according to embodiments of the present disclosure is illustrated. The exemplary message sequence diagram illustrates enabling the V-SMF to send notifications to AF via H-SMF or directly to AF or H-NEF in the HR-SBO scenario illustrated in FIG. 5.

According to an aspect, the exemplary message sequence diagram of the method or process for managing a data session (e.g., a PDU session) in a HR-SBO mode (also briefly referred to as HR-SBO session) according to embodiments of the present disclosure shown in FIG. 8 concerns providing notification endpoint information such as a notification Unified Resource Identifier (URI) to V-SMF. Thereby, the V-SMF is enabled to send notifications such as user plane change events, i.e., early/late notifications due to UE mobility to AF via the home network, mainly via H-SMF. In addition, in case the visited network (or the V-SMF) supports EAS IP replacement capability, the information on support of this capability may also be provided to the AF.

The exemplary message sequence diagram of the method or process for managing the data session in the HR-SBO mode according to embodiments of the present disclosure shown in FIG. 8 may represent, or supplement, the procedure of EAS re-discovery and edge relocation when HR-SBO is supported and allowed in the target serving PLMN as specified in clause 6.7.3.2 of 3GPP TS 23.548.

In step 0, the procedures as specified in clauses 6.7.2.6, 6.7.2.7 and 6.7.2.9 of 3GPP TS 23.548 such as the inter V-SMF inter-PLMN N2 handover or mobility registration (step 0a) in the HR-SBO scenario; or inter V-SMF intra-PLMN N2 handover or Xn handover or mobility registration update (step 0b) in HR-SBO scenario may be performed.

In step 1, in case the procedures of step 0a are performed, if the AF had subscribed to the corresponding event and a serving PLMN change occurred towards a PLMN where local traffic offload is possible for the PDU session, the H-SMF may notify the AF, indicating the new serving PLMN ID as well as HPLMN DNN and S-NSSAI for HR-SBO session. This may take place as soon as the H-SMF has received an indication of Handover Complete (i.e., step 13 of the procedure specified in clause 6.7.2.6 of 3GPP TS 23.548).

Via the mechanism of step 1, the AF is aware of the PLMN to contact to issue traffic influence requests for HR-SBO sessions, if available, with HPLMN DNN and S-NSSAI information. The AF is assumed to check whether the AF has an SLA with the new serving PLMN. If the AF has no SLA with the new serving VPLMN, the AF interacts with H-NEF to issue traffic influence requests. This may trigger the AF triggered edge relocation/EAS rediscovery as specified in step 1b of clause 6.2.3.3 and in step 4a of clause 6.3.3.1.1 of 3GPP TS 23.548.

In step 2a, for AF triggered EAS re-discovery and edge relocation via interacting with HPLMN, the AF may indicate the EAS rediscovery for the impacted applications, which are identified by Application Identifier(s), to the H-SMF via the H-PCF using the AF influence on traffic routing procedure as specified in clause 4.3.6 of 3GPP TS 23.502. The AF may also provide EAS IP replacement information and target DNAI together with an indication of the PLMN associated with this target DNAI, i.e., the serving PLMN ID.

In step 2b, for AF triggered EAS re-discovery and edge relocation via interacting with serving VPLMN, the AF may indicate the EAS rediscovery for the impacted applications via the V-NEF using the procedure as specified in clause 4.3.6 of 3GPP TS 23.502.

The AF may also provide EAS IP replacement information and target DNAI to the VPLMN (i.e., V-SMF) in which case steps 3 and 4 as described hereinbelow may be skipped.

In step 3a, for AF triggered EAS re-discovery and edge relocation via interacting with HPLMN, the AF traffic influence request information (i.e., Application Function influence on traffic routing Enforcement Control information) may be sent to H-SMF via one or more PCC rules. This may trigger step 2 of the procedure specified in clause 6.2.3.3 of 3GPP TS 23.548 where the SMF that initiates the PDU session modification is the H-SMF.

For example, the H-SMF may issue a Nsmf_PDUSession_Update request which may contain EAS IP replacement information and target DNAI provided by the AF in step 2.

According to embodiments of the present disclosure, the H-SMF may include its own notification URI to which the V-SMF may provide any notification which is eventually forwarded by the H-SMF to the AF (either directly or via the H-NEF). The Nsmf_PDUSession_Update request may also include policies due to AF provided traffic influence information (e.g., the AF TI container as described above).

Further in step 3a, if the V-SMF cannot serve the target DNAI, the V-SMF may invoke a Nsmf_PDUSession_SMContextStatusNotify service operation to send the target DNAI to the AMF, and the AMF may select a target V-SMF based on the target DNAI as specified in clause 4.23.5.4 of 3GPP TS 23.502 by replacing the I-SMF with the V-SMF. The target V-SMF retrieves SM context from the source V-SMF using Nsmf_PDUSession_Context Request/Response, containing Authorization Result for HR-SBO, EAS IP replacement information and target DNAI in the request. The target V-SMF may select a new V-EASDF in accordance with the procedure as specified in steps 2 to 12 of clause 6.7.2.6 of 3GPP TS 23.548.

According to embodiments of the present disclosure, the Nsmf_PDUSession_Context Request/Response may further include the notification URI.

In step 3b, for AF triggered EAS re-discovery and edge relocation via interacting with VPLMN, the V-SMF may initiate the Nsmf_PDUSession_Update request with the EAS rediscovery indication and the impact field to the H-SMF, and the H-SMF may initiate the Nsmf_PDUSession_Update response towards the (target) V-SMF including the PCO information to be sent to the UE as specified in step 2 of clause 6.2.3.3 of 3GPP TS 23.548. In intra-PLMN V-SMF change, the target V-SMF may use the source and target DNAI to determine the impact field to be sent to the UE. In inter-PLMN mobility, the target V-SMF may provide EAS rediscovery information without an impact field.

According to embodiments of the present disclosure, the V-SMF may send a notification to the received notification URI from the H-SMF if the AF had subscribed to user plane management event notifications such as a DNAI change, PSA UPF relocation, or EAS replacement capability to the H-SMF, and to the H-SMF provided notification URI.

In step 4, the V-SMF may initiate PDU session modification command including the PCO to the UE. The PCO may include EAS rediscovery indication (optional) and the impact field (optional).

Finally, in step 5, the V-SMF may configure the V-UPF (UL CL and L-PSA) with EAS IP replacement information.

The exemplary message sequence diagram of the method or process for managing the data session in the HR-SBO mode according to embodiments of the present disclosure as described with reference to FIG. 8 enables the V-SMF to provide the required notification information to the AF (either trusted or non-trusted third-party AF).

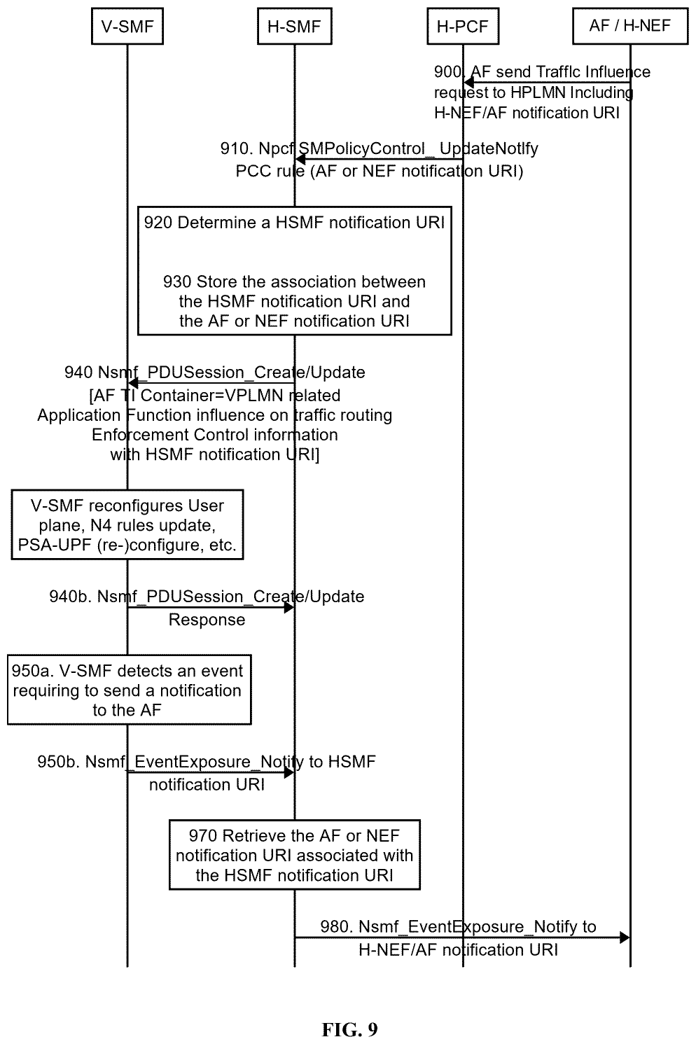

In an example of the exemplary message sequence diagram of the method or process for managing the data session in the HR-SBO mode according to embodiments of the present disclosure, the notification endpoint information (e.g., the notification URI) may be provided to the V-SMF as part of the signaling described above with reference to FIG. 7, e.g., via the AF TI container. In this case, the H-SMF may change the NEF information parameter that is used as the Notification Endpoint of NEF subscription to be notified to the H-SMF itself. The H-SMF may also maintain internally an indication of the URI information to which V-SMF notifications are to be forwarded to the AF (directly or via H-NEF). That is, the H-SMF handles any notification from the V-SMF and re-maps the notification to the H-NEF. This aspect is further described in FIG. 9.

In another example of the method or process for managing the data session in the HR-SBO mode according to embodiments of the present disclosure, VPLMN-related Application Function influence on traffic routing Enforcement Control information including notification URI information may be provided as part of SM context exchanged between V-SMF and H-SMF (e.g., as part of a V-SMF insertion procedure) or exchanged between source V-SMF and target V-SMF (e.g., as part of a V-SMF change procedure) as part of AF coordination information containing the notification URI IE.

For example, the notification URI IE as well as EAS IP replacement information may be included in the SM context table as specified in Table 5.2.8.2.10-1 of 3GPP TS 23.502:

TABLE
SM Context of a PDU Session transferred between I-SMF(s) or
between V-SMF(s) or between I/V-SMF and (H-)SMF

| Field | Description |
|---|---|
| SUPI | SUPI (Subscription Permanent |
| | Identifier) is the subscriber's |
| | permanent identity in 5GS. |
| Trace Requirements | Trace reference: Identifies a |
| | record or a collection of records |
| | for a particular trace. |
| | Trace type: Indicates the type of trace |
| | OMC identity: Identifies the OMC |
| | that shall receive the trace |
| | record(s). |
| S-NSSAI | The S-NSSAI of the PDU Session |
| | for the serving PLMN. |
| HPLMN S-NSSAI | The S-NSSAI of the PDU Session |
| | for the HPLMN (Home- |
| | Routed PDU Session) |
| Network Slice Instance | The network Slice Instance |
| id | information for the PDU Session |
| DNN | The associated DNN for the PDU Session. |
| AMF Information | The associated AMF instance |
| | identifier and GUAMI. |
| Access Type | The current access type for this |
| | PDU Session. |
| RAT Type | RAT Type for this PDU Session. |
| PDU Session ID | The identifier of the PDU Session. |
| H-SMF Information or | The associated H-SMF identifier |
| SMF Information | and H-SMF address for the |
| | HR PDU Session (applies only |
| | for a V-SMF), or the SMF |
| | identifier and SMF address for |
| | PDU Session (applies for I- |
| | SMF). |
| Context ID of the PDU | The context ID of the PDU Session |
| Session in H-SMF or | in H-SMF or in SMF. |
| Context ID of the PDU | |
| Session in SMF | |
| Forwarding Indication | An indication on whether |
| | forwarding tunnel needs be |
| | established in order to |
| | forward buffered DL data. |
| Uplink Tunnel Info of | The Tunnel Information to be |
| UPF controlled by the | used to send UL traffic |
| SMF/H-SMF | towards the UPF controlled |
| | by the SMF/H-SMF that |
| | interfaces the UPF controlled |
| | by the I-SMF. |
| Tunnel Info of NG-RAN | The N3 Tunnel Information in |
| | the NG-RAN for the PDU |
| | Session. This information is |
| | transferred if the target I/V-SMF |
| | indicates no NG-RAN change. |
| Disaster Roaming | An indication that the UE is |
| | registered for Disaster Roaming |
| | service. |
| EAS information to be | Identifies EAS(s) which needs to |
| refreshed for EAS re- | be refreshed corresponding |
| discovery | to the old target DNAI if available. |
| | See details in clause 6.7.3 |
| | of 3GPP TS 23.548. This applies |
| | only for a V-SMF (for V- |
| | SMF change case) or H-SMF |
| | (for V-SMF insertion case). |
| Authorization Result for | Indicates whether HR-SBO |
| HR-SBO | is authorized. See details in |
| | clause 6.7.3 of 3GPP TS 23.548. |
| | This applies only for a V- |
| | SMF (for V-SMF change within |
| | same PLMN case). |
| VPLMN Specific | Includes traffic description |
| Offloading Information | information authorized for HR- |
| | SBO in VPLMN and the |
| | corresponding policy for the traffic. |
| | See details in clause 6.7.3 of |
| | 3GPP TS 23.548 (for V-SMF |
| | change within same PLMN case). |
| HPLMN address | Identifies the address information |
| information | in HPLMN (e.g. H-UPF IP |
| | address on N6). See details in |
| | clause 6.7.3 of 3GPP |
| | TS 23.548. This applies for a |
| | V-SMF (for V-SMF change |
| | case), H-SMF (for V-SMF insertion). |
| DNS Server address | Identifies the DNS Server |
| provided by HPLMN | provided by HPLMN to VPLMN |
| | for HR-SBO. See details in clause |
| | 6.7.3 of 3GPP TS 23.548. |
| | This applies for a V-SMF (for |
| | V-SMF change case), H-SMF |
| | (for V-SMF insertion). |

AF Coordination Information:

| | |
|---|---|
| Source DNAI | The DNAI from where the UE is moving. |
| UE IP address in Source | The UE IP address in the Source DNAI. |
| DNAI | |
| List of Notification | Notification Correlation IDs for |
| Correlation IDs | UP path change event as |
| | received in the PCC Rules |
| For each notification | Uplink buffering indication as |
| correlation ID: Uplink | received from the AF for this |
| buffering indication | notification correlation id during |
| | Early Notification. |

For each QoS Flow in the PDU Session:

| | |
|---|---|
| 5G QoS Identifier (5Q1) | Identifier for the authorized |
| | QoS parameters for the service |
| | data flow. |
| ARP | The Allocation and Retention |
| | Priority for the service data |
| | flow consisting of the priority |
| | level, the pre-emption |
| | capability, and the pre-emption |
| | vulnerability. |
| GFBR | Guaranteed Flow Bit Rate |
| | (GFBR)-UL and DL. |
| MFBR | Maximum Flow Bit Rate |
| | (MFBR)-UL and DL. |
| Priority Level | Indicates a priority in scheduling |
| | resources among QoS |
| | Flows. |
| Averaging Window | Represents the duration over |
| | which the guaranteed and |
| | maximum bitrate shall be calculated. |
| Maximum Data Burst | Denotes the largest amount |
| Volume | of data that is required to be |
| | transferred within a period |
| | of 5G-AN PDB. |
| Reflective QoS Control | Indicates to apply reflective QoS |
| | for the SDF in the TFT. |
| QoS Notification | Indicates whether notifications |
| Control (QNC) | are requested from 3GPP |
| | RAN when the GFBR can no |
| | longer (or can again) be |
| | guaranteed for a QoS Flow |
| | during the lifetime of the QoS |
| | Flow. |
| Maximum Packet Loss | Maximum Packet Loss |
| Rate | Rate-UL and DL. |

Mapped EPS Bearer Context for Each QFI to support
interworking with EPS:

| | |
|---|---|
| EPS Bearer Id | An EPS bearer identity uniquely |
| | identifies an EPS bearer for |
| | one UE accessing via E-UTRAN. |
| TI | The GERAN/UTRAN Transaction |
| | ID (if any) that is |
| | associated with the EPS Bearer ID |
| | which is part of the Bearer |
| | Context received from the MME. |
| BSS Container | The GERAN BSS Container |
| | (if any) that is associated with |
| | the EPS Bearer ID which is |
| | part of the Bearer Context |
| | received from the MME. |
| Mapped EPS Bearer | ARP, GBR, MBR, QCI. |
| QoS | |
| PGW-U tunnel | PGW-U S5/S8 GTP-U tunnel IP |
| Information | address and TEID information. |
| TFT | Traffic Flow Template. |

According to embodiments of the present disclosure, the SM context table may further include the following:

| Field | Description |
|---|---|
| AF TI Container | Container to carry the AF Traffic |
| | Influence Information |

AF Coordination Information:

| | |
|---|---|
| Notification URI | Notification URI for V-SMF to send |
| | its notification for UP path change |
| | event in case AF interacts with HPLMN to |
| | influence HR-SBO traffic at VPLMN. |

When the H-SMF notifies the AF (or the H-NEF) regarding the described events in Table 5.2.8.3.1-1 of 3GPP TS 23.502: Example of Event Filters for SMF exposure events and clause 5.2.8.3.2 of 3GPP TS 23.502 that is/are applicable to HR-SBO session served by VPLMN (V-SMF), the H-SMF may include capability of supporting EAS IP replacement in 5GC with PLMN ID of VPLMN.

In case VPLMN (V-SMF) supports EAS IP replacement capability, acknowledgement notification from the V-SMF regarding UE PDU Session related event(s) may also be relayed via the H-SMF as part of Nsmf_EventExposure_AppRelocationInfo service operation specified in clause 5.2.8.3.2A of 3GPP TS 23.502. This notification may also include cause code that indicates the acknowledgement is positive or negative. Therefore, PLMN ID or SMF ID may be considered as part of input parameters of this service to distinguish whether the acknowledgement is for H-SMF or V-SMF.

According to another aspect, the exemplary message sequence diagram of the method or process for managing the data session in the HR-SBO mode according to embodiments of the present disclosure shown in FIG. 8 concerns enabling the V-SMF to provide required notification information to the AF (either trusted or non-trusted third-party AF) either directly or via the H-NEF.

In an example, a direct notification to the AF may require an SLA between PLMN and the third-party AF. The AF may request for notification from 5GC and provide its notification URI. In case the request is sent via NEF, NEF provides its own/translated URI to PCF/SMF as specified in clause 4.3.6.2 of 3GPP TS 23.502, for example.

According to embodiments of the present disclosure, in step 3a shown in FIG. 8, the H-SMF may forward the received notification to the V-SMF as part of the Nsmf_PDUSession_Update procedure. The H-SMF may indicate if the URI is of H-NEF (in the HPLMN) or the AF as part of the notification URI owner in above table. The V-SMF may send notification directly to the AF (if there is SLA in place) or to the H-NEF, which in turn forwards the information to the AF.

Now referring to FIG. 9, another exemplary message sequence diagram of the method or process for managing a data session in a HR-SBO mode according to embodiments of the present disclosure is illustrated. The exemplary message sequence diagram illustrates details to enable the V-SMF to send notifications towards AF via H-SMF in the HR-SBO scenario illustrated in FIG. 5.

According to an aspect, the exemplary message sequence diagram of the method or process for managing a data session (e.g., a PDU session) in a HR-SBO mode according to embodiments of the present disclosure shown in FIG. 9 concerns providing notification endpoint information to V-SMF. Thereby, the V-SMF is enabled to send notifications on events on the PDU session to AF via the home network, mainly via H-SMF.

In step 900, the H-PCF in the home network (e.g., the H-PCF 506-1 shown in FIG. 5) receives a request originated by an AF of the HPLMN to influence traffic routing, where the request targets a PDU session controlled by this H-PCF. In some examples, step 900 may correspond to steps 710-714A or step 710B of FIG. 7

In step 910, the H-SMF in the home network (e.g., the H-SMF 505-1 shown in FIG. 5) may receive from the H-PCF in the home network (e.g., the H-PCF 506-1 shown in FIG. 5) a request for notification on events on the PDU session. The request for notification on events on the PDU session may be a subset of Application Function influence on traffic routing Enforcement Control information sent by H-PCF to H-SMF and include notification endpoint information either associated with the AF (e.g., the AF 507-1 shown in FIG. 5) or associated with the H-NEF of the home network (e.g., the H-NEF 513-1 shown in FIG. 5). The notification endpoint information may comprise a notification URI associated with the AF or the H-NEF. In some examples, step 910 may correspond to step 720 of FIG. 7.

In step 920, the H-SMF may associate a notification endpoint at the H-SMF with the notification endpoint at the AF or the H-NEF received in Application Function influence on traffic routing Enforcement Control information sent by H-PCF to H-SMF. That is, the H-SMF may associate a notification endpoint information associated with itself (the H-SMF) with the notification endpoint information associated with the AF or the H-NEF, received in step 910. Forcing the notifications from V-SMF to go via the H-SMF allows avoiding creating a direct interface from V-SMF to H-NEF/AF of the HPLMN, which would mean a new inter-operator interworking point and thus a new inter operator interface to manage (which operators tend to avoid).

In step 930, the H-SMF may store the association between the notification endpoint at the H-SMF and the notification endpoint received in Application Function influence on traffic routing Enforcement Control information sent by H-PCF to H-SMF (notification endpoint at the AF or the H-NEF). That is, the H-SMF may store the association between the notification endpoint information associated with the H-SMF and the notification endpoint information associated with the AF or the H-NEF, received in step 910.

In step 940, the H-SMF may provide the notification endpoint information associated with the H-SMF to the V-SMF in the visited network (e.g., the V-SMF 505-2 shown in FIG. 5), as the notification endpoint information to be used by the V-SMF to send notifications on events on the PDU session towards the AF. The H-SMF may provide the notification endpoint information associated with the H-SMF as part of the VPLMN-related Application Function influence on traffic routing Enforcement Control information sent to V-SMF. For example, the H-SMF may send a message (e.g., Nsmf_PDUSession_Create/Update) including an information element or a container (e.g., the AF TI container as described above) dedicated to the VPLMN-related Application Function influence on traffic routing Enforcement Control information and including the notification endpoint information associated with the H-SMF (e.g., the notification URI associated with the H-SMF).

The V-SMF may then consider the VPLMN-related Application Function influence on traffic routing Enforcement Control information (i.e., the information in the AF TI container) and (re-)configures the user plane (UP) of the PDU Session based on the VPLMN-related Application Function influence on traffic routing Enforcement Control information to influence traffic for the PDU session in the HR-SBO mode as described above with reference to step 740 of FIG. 7.

In step 940b, the V-SMF may acknowledge the VPLMN-related Application Function influence on traffic routing Enforcement Control information received in step 940. For example, the V-SMF may send a message (e.g., Nsmf_PDUSession_Create/Update Response) to the H-SMF to acknowledge receipt of the message (e.g., Nsmf_PDUSession_Create/Update) received in step 940.

In step 950a, the V-SMF may detect an event requiring to send a notification per the VPLMN-related Application Function influence on traffic routing Enforcement Control information. In response, the V-SMF may in step 950b send a notification to the H-SMF, where the notification targets the notification endpoint at the H-SMF. The V-SMF may use the notification endpoint information associated with the H-SMF, received in step 940, to send the notifications to the H-SMF. For example, the V-SMF may send a Nsmf_EventExposure_Notify to the notification URI associated with the H-SMF.

In response to receiving the notification from the V-SMF, the H-SMF may retrieve, or determine, a notification endpoint information to be used by the H-SMF to forward the notification to the AF or the H-NEF in step 970. The H-SMF may use the notification endpoint information used by the V-SMF in step 950b to retrieve, or determine, the notification endpoint information associated with the AF or the H-NEF based on the association stored in step 930. For example, the H-SMF may retrieve the notification endpoint received by the H-SMF in the PCC rule, that had been associated with the notification endpoint at the H-SMF at step 920.

In step 980, the H-SMF may forward the received notification using the notification endpoint information associated with the AF or the H-NEF towards the AF (e.g., via the H-NEF). For example, the H-SMF may send a Nsmf_EventExposure_Notify including the notification to the notification URI associated with the AF or the H-NEF. The embodiments of the present disclosure as described above enhance the H-SMF functionalities and corresponding interface to enable AF traffic influence request for HR-SBO session to V-SMF, the H-SMF functionalities and corresponding interface with the H-SMF to relay notifications sent from the V-SMF to the AF in a way that the H-SMF differentiates the notifications sent to the AF (i.e., whether the notification is from V-SMF(s) or its own notification), and enables the H-SMF to provide notification URI and indicate whether this notification URI belongs to H-SMF itself, H-NEF or AF.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

It is noted that whilst embodiments have been described in relation to LTE and 5G NR, similar principles can be applied in relation to other networks and communication systems where enforcing fast connection re-establishment is required. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes exemplary embodiments, there are several variations and modifications which may be made to the disclosed solution without departing from the scope of the present disclosure.

In general, the various exemplary embodiments may be implemented in hardware or special purpose circuits, software, logic, or any combination thereof. Some aspects of the present disclosure may be implemented in hardware, while other aspects may be implemented in firmware or software which may be executed by a controller, microprocessor, or other computing device, although the present disclosure is not limited thereto. While various aspects of the present disclosure may be illustrated and described as block diagrams, flow charts, or using some other pictorial representation, it is well understood that these blocks, apparatus, systems, techniques, or methods described herein may be implemented in, as non-limiting examples, hardware, software, firmware, special purpose circuits or logic, general purpose hardware or controller or other computing devices, or some combination thereof.

Embodiments of the present disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the figures may represent program steps, or interconnected logic circuits, blocks and functions, or a combination of program steps and logic circuits, blocks, and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor-based memory devices, magnetic memory devices and systems, optical memory devices and systems, fixed memory, and removable memory. The data processors may be of any type suitable to the local technical environment, and may comprise one or more of general-purpose computers, special purpose computers, microprocessors, digital signal processors (DSPs), application specific integrated circuits (ASICs), FPGA, gate level circuits and processors based on multi-core processor architecture, as non-limiting examples.

Embodiments of the present disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of non-limiting examples a full and informative description of exemplary embodiments of the present disclosure. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of the present disclosure as defined in the appended claims. Indeed, there is a further embodiment comprising a combination of one or more embodiments with any of the other embodiments previously discussed.

1. A method for management of a data session in a home routed (HR) session breakout (SBO) mode, the method comprising:
receiving, by a home policy control (H-PCF) of a home network, from an application function (AF), a request to influence traffic for a data session;
generating, by the H-PCF, one or more policy and charging control (PCC) rules based on the request, wherein a PCC rule of the one or more PCC rules comprises the request to influence traffic for the data session; and
providing, by the H-PCF, to a home session management function (H-SMF), the one more PCC rules; and
providing, by the H-SMF, to a visited session management function (V-SMF) of a visited network, information on how to influence traffic routing for the data session served by the visited network, the information on how to influence traffic routing for the data session based on at least the PCC rule of the one or more PCC rules, the information on how to influence traffic for use configuring, by the V-SMF, at least a user plane (UP) function of the visited network based on the information on how to influence traffic routing for the data session.

2. The method of claim 1, further comprising:
determining, by the H-SMF, the information on how to influence traffic routing for the data session based on the at least one PCC rule of the one or more PCC rules provided by the H-PCF.

3. The method of claim 1, wherein the information on how to influence traffic routing for the data session includes a subscription request to notifications of any user plane management events received from the AF.

4. The method of claim 1, wherein the information on how to influence traffic routing for the data session comprises one or more of: information to identify the traffic, information about one or more data network access identifiers (DNAIs) of the visited network, an indication of traffic correlation, an indication of application relocation possibility, an indication of address preservation for a user equipment, a request to be notified when a UP path of the data session has changed.

5. The method of claim 4, wherein the information on how to influence traffic routing for the data session further comprises, per DNAI, a traffic steering policy identifier and/or traffic routing information related to the interface between a user plane function (UPF) and a data network (DN).

6. The method of claim 1, wherein the providing, by the H-SMF, to the V-SMF, the information on how to influence traffic routing for the data session comprises sending, by the H-SMF, to the V-SMF, a session management (SM) message or a SM context including an information element or a container to provide the information on how to influence traffic routing for the data session.

7. The method of claim 1, further comprising:
providing, by the H-SMF to the V-SMF, offloading rules or information on how the visited network should influence traffic routing for the data session.

8. The method of claim 1, further comprising:
mapping, by the H-SMF, parameters of the request to influence traffic for the data session from the one or more PCC rules to parameters to be exchanged between the H-SMF and the V-SMF and providing, by the H-SMF to the V-SMF, the mapped parameters in a session management message; and
expanding the session management message or context with parameters of the request to influence traffic for the data session not mapped to existing parameters of the session management message.

9. The method of claim 1, wherein the providing, by the H-SMF to the V-SMF, the information on how to influence traffic routing for the data session comprises providing, by the H-SMF to the V-SMF, a notification endpoint information, the notification endpoint information for use by the V-SMF to send notifications towards the AF via the home network.

10. The method of claim 9, further comprising:
receiving, by the H-SMF, a request for notification on events on the data session, the request indicating the notification is to include the notification endpoint information, wherein the notification endpoint information is to be that either associated with the AF or associated with a home network exposure function (H-NEF) of the home network via which the request from the AF is received when the H-SMF does not provide its own notification endpoint information; and
when the H-SMF does not provide its own notification endpoint information, providing, by the H-SMF, to the V-SMF, an indication that the notification endpoint information provided is notification endpoint information associated with the AF or notification endpoint information associated with the H-NEF.

11. The method of claim 9, further comprising:
receiving, by the H-SMF, a request for notification on events on the data session, the request indicating the notification is to include the notification endpoint information, wherein the notification endpoint information is to be that either associated with the AF or associated with a home network exposure function (H-NEF) of the home network;
associating, by the H-SMF, a notification endpoint information associated with the H-SMF with the received notification endpoint information;
storing, by the H-SMF, the association between the notification endpoint information associated with the H-SMF and the received notification endpoint information;
providing, by the H-SMF, to the V-SMF, the notification endpoint information associated with the H-SMF as the notification endpoint information to be used by the V-SMF to send notifications on events on the data session towards the AF;
receiving, by the H-SMF, from the V-SMF, a notification on an event sent using the notification endpoint information associated with the H-SMF;
retrieving, by the H-SMF, the notification endpoint information to be used by the H-SMF to forward the notification based on the association; and
forwarding, by the H-SMF towards the AF, the notification on the event using the retrieved notification endpoint information.

12. An apparatus for communication, the apparatus comprising:
at least one processor; and
at least one memory storing instructions of a home session management function (H-SMF) for a home network that, when executed by the at least one processor, cause the apparatus at least to:
determine information on how to influence traffic routing for a data session in a home routed (HR) session breakout (SBO) mode served by a visited network based on one or more policy and charging control (PCC) rules received from a home policy control function (H-PCF) of the home network, wherein a PCC rule of the one or more PCC rules comprises a request to influence traffic for the data session that was received by the H-PCF from an application function (AF);
provide, to a visited session management function (V-SMF) of the visited network, the information on how to influence traffic routing for the data session, the information on how to influence traffic routing for the data session for use by the V-SMF to configure at least a user plane (UP) function.

13. The apparatus of claim 12, wherein the instructions are further configured to cause the apparatus at least to:
receive, from the H-PCF, the one or more PCC rules, the one or more PCC rules having been generated based on the request to influence traffic for the data session from the AF.

14. The apparatus of claim 12, wherein the information on how to influence traffic routing for the data session includes the request to influence traffic for the data session received from an application function (AF).

15. The apparatus of claim 12, wherein the information on how to influence traffic routing for the data session comprises one or more of: information to identify the traffic, information about one or more data network access identifiers (DNAIs) of the visited network, an indication of traffic correlation, an indication of application relocation possibility, an indication of address preservation for a user equipment, a request to be notified when a UP path of the data session has changed.

16. The apparatus of claim 15, wherein the information on how to influence traffic routing for the data session further comprises, per DNAI, a traffic steering policy identifier and/or traffic routing information related to the interface between a user plane function (UPF) and a data network (DN).

17. The apparatus of claim 12, wherein the instructions are further configured to cause the apparatus at least to:
send, to the V-SMF, a session management (SM) message or a SM context including an information element or a container to provide the information on how to influence traffic routing for the data session.

18. The apparatus of claim 12, wherein the instructions are further configured to cause the apparatus at least to perform:
provide, to the V-SMF, offloading rules or information on how the visited network should influence traffic routing for the data session.

19. The apparatus of claim 12, wherein the instructions are further configured to cause the apparatus at least to performing:
map parameters of the request to influence traffic for the data session from the one or more PCC rules to parameters to be exchanged between the H-SMF and the V-SMF and provide, to the V-SMF, the mapped parameters in a session management message; and
expand the session management message or context with the parameters of the request to influence traffic for the data session that are not mapped to existing parameters of the session management message.

20. The apparatus of claim 12, wherein the instructions are further configured to cause the apparatus at least to:
provide, to the V-SMF, a notification endpoint information, the notification endpoint information for use by the V-SMF to send notifications towards the AF via the home network.

21. The apparatus of claim 20, wherein the instructions are further configured to cause the apparatus at least to:
receive a request for notification on events on the data session, the request indicating the notification is to include the notification endpoint information, wherein the notification endpoint information is to be that either associated with the AF or associated with a home network exposure function (H-NEF) of the home network via which the request from the AF is received when the H-SMF does not provide its own notification endpoint information; and
when the H-SMF does not provide its own notification endpoint information, provide, to the V-SMF, an indication that the notification endpoint information provided is notification endpoint information associated with the AF or notification endpoint information associated with the H-NEF.

22. The apparatus of claim 20, wherein the instructions are further configured to cause the apparatus at least to:
receive a request for notification on events on the data session, the request indicating the notification is to include the notification endpoint information, wherein the notification endpoint information is to be that either associated with the AF or associated with a home network exposure function (H-NEF) of the home network;
associate a notification endpoint information associated with the H-SMF with the received notification endpoint information;
store the association between the notification endpoint information associated with the H-SMF and the received notification endpoint information;
provide, to the V-SMF, the notification endpoint information associated with the H-SMF as the notification endpoint information to be used by the V-SMF to send notifications on events on the data session towards the AF;
receive, from the V-SMF, a notification on an event sent using the notification endpoint information associated with the H-SMF;
retrieve the notification endpoint information to be used by the H-SMF to forward the notification on the event based on the association; and
forward, towards the AF, the notification on the event using the retrieved notification endpoint information.
